(19) United States
(12) Patent Application Publication
(10) Pub. No.: US 2013/0173712 A1
(43) Pub. Date: Jul. 4, 2013

(54) METHOD FOR SELECTIVELY DISTRIBUTING INFORMATION IN A COMPUTER OR COMMUNICATION NETWORK, AND PHYSICAL ENTITIES THEREFOR

(71) Applicants: Miguel Angel Monjas Llorente, Madrid (ES); José María Del Álamo Ramiro, Alcorcon (Madrid) (ES); Beatríz San Miguel González, Madrid (ES); Rubén Trapero Burgos, Alcorcon (Madrid) (ES); Juan Carlos Yelmo García, Mostoles (Madrid) (ES)

(72) Inventors: Miguel Angel Monjas Llorente, Madrid (ES); José María Del Álamo Ramiro, Alcorcon (Madrid) (ES); Beatríz San Miguel González, Madrid (ES); Rubén Trapero Burgos, Alcorcon (Madrid) (ES); Juan Carlos Yelmo García, Mostoles (Madrid) (ES)

(73) Assignees: UNIVERSIDAD POLITENICA DE MADRID, Madrid (ES); TELEFONAKTIEBOLAGET LM ERICSSON (publ), Stockholm (SE)

(21) Appl. No.: 13/809,503

(22) PCT Filed: Jun. 30, 2010
(86) PCT No.: PCT/EP10/59264

§ 371 Date: Jan. 10, 2013

(51) Int. Cl. H04L 29/06

(52) U.S. Cl. CPC H04L 65/403
USPC 709/204

(57) ABSTRACT

A method is carried out by a controller (100), a social network (200), a provider (300) and a terminal (400) of a primary user (450). After a trust relationship is set up (s10) between the controller (300) and social network (200), the terminal (400) accesses (s20) the provider (300). The provider (300) transmits (s30) to the terminal (400) a proposal to provide information relating to the provider (300) to secondary users of the primary user in the social network (200). If the terminal (400) accepts (s40) the proposal, the provider (300) transmits (s30) to the controller (100) a message including the information relating to the provider (300). The controller (300) obtains identification of the primary user (450) to whom the message relates and triggers (s70) transmission, to the secondary users, of the information relating to the provider (300). A controller (100), a system (500) and computer programs are also disclosed.

### TECHNICAL FIELD

The present invention relates to the selective distribution of information in a computer or communication network. In particular, the invention relates to methods carried out by physical entities for performing such a distribution, and to physical entities configured therefor. The invention also relates to computer programs comprising instructions configured, when executed on a computer, to cause the computer to act in accordance with the above-mentioned methods.

### BACKGROUND

There is a vast array of information available to users in a computer or communications network such as the Internet. The technology is also available to provide a communication infrastructure enabling fast, efficient and reliable transport of this information from the providers of information, which may for instance store the information on web servers, to the users. Search engines are also available to assist users in identifying information of interest to them among the available information, or at least among the information indexed by the search engines.

Yet, users of computer or communications networks may not be aware of the very existence and availability of information which may be of interest to them, and the users may consequently not search for this information at the outset.

The word of mouth distribution of information, i.e. passing information from person to person, constitutes another channel to assist users in identifying information of interest to them. For instance, document US 2005/0149397 proposes, in a particular field, a method for realizing an online automated version of word of mouth communication via a communications network.

The need for distributing information to users in a computer or communications network, without swamping the users with a mass of information, extends to many situations and has revealed the need for selectively distributing information.

For instance, let us imagine a situation wherein a student who, as part of a temporary student exchange programme, moves to California, where there is a large tsunami hazard zone, although not everybody knows this. Upon arriving in California, the visiting student receives a welcome email from his or her host university in California prompting him or her to access the local university web portal and in particular a page entitled “important information for visiting students”. The page contains a link to a document such as (for instance) http://www.conservation.ca.gov/cgs/geologic_hazards/Tsunami/Documents/TsunamiBrochure.pdf (a document entitled “How to Survive a Tsunami”, prepared by the California Emergency Management Agency Earthquake and Tsunami Program, retrieved from the Internet on Jun. 29, 2010). The student is therefore prompted to read important information explaining how to react in a situation involving a risk of tsunami.

This example illustrates a situation wherein important, life-saving information is selectively and timely distributed to users in a computer or communications network.

It is desirable to improve the methods, physical entities and computer programs used to selectively and timely distribute information to users in a computer or communications network, with in mind the need of reducing the operational burden on the users.

### SUMMARY

To meet or to at least partially meet these objectives, a method, a controller and a computer program are defined in the independent claims. Advantageous embodiments are defined in the dependent claims.

In one embodiment, a method is carried out by at least the following elements: a controller, at least one social network, a provider, and a terminal of a user, here referred to as primary user. Each of the at least one social network is at least one of a software application and a web site that is at least configured to maintain profiles of at least the primary user and other users, here referred to as secondary users, who are associated with the primary user in the social network. The provider is at least one of a software application and a web site that is at least configured to present and/or offer information, services and/or goods to users. The method includes setting up a trust relationship between the controller and each of the at least one social network; accessing, by the terminal of the primary user, the provider; transmitting, by the provider to the terminal of the primary user, a proposal to provide information relating to the provider at least to some or all secondary users associated with the primary user in the at least one social network; accepting, by the terminal of the primary user, the proposal; transmitting, by the provider to the controller, a message including or identifying the information relating to the provider; obtaining, by the controller, identification of the primary user to whom the message relates; and triggering, by the controller, the transmission, to some or all secondary users associated with the primary user in the at least one social network, of the information relating to the provider.

The controller is a physical entity, which may include a computer program or hardware circuitry for executing the functions of the controller. The controller may for instance be integrated with a server computer. The controller may also be constituted from a plurality of server computers carrying out together the functions of the controller. The controller acts as intermediary node between the providers and the social networks for the benefit of the users, the providers and the social networks.

A social network is a software application and/or a web site configured for maintaining profiles of users and associations between users. Users typically enjoy a personal computer-implemented space enabling them to maintain a personal profile. A user can also typically communicate and conveniently share information with other users with whom the user is associated in the social network. Such a social network application or, simply, social network is also called online social network.

In the present context, the method will be described from the perspective of one user of a social network. This user is here referred to as primary user. The other users with whom the primary user is associated within the social network are here referred to as secondary users.

A provider is a computer-implemented application and/or a web site that is at least configured to present and/or offer information, services and/or goods to users. A provider may for instance be any web site providing information useful to users, whether accessing the information is free of charge or not. A provider may for instance be a web site providing information regarding local weather conditions, a provider may be an online bookstore, a repository of multimedia files, etc.

The provider may be, as mentioned above, configured to offer a service or services. In that context, offering of a service is a technical and economical activity which may for instance result in the ownership of physical goods through a sale, modification of the technical characteristics of a computer configuration, etc. The service may be a web service.

The terminal may be any communication device such as a mobile phone, a smart phone, a desktop computer, a laptop, a tablet computer, or the like. When it is here referred to “a terminal of a user”, this does not require the terminal to be owned by the user. It suffices that the terminal is used by the user or on his or her behalf. In that respect, a terminal programmed to automatically carry out a number of tasks on behalf of a user, without requiring the active presence at all time of the user, is also considered to be a terminal of a user.

A user is a human or group of humans whose identity can be authenticated, or by extension the user is the computer-understandable identity of the human or group of humans. The identity may be attached to the terminal. Moreover, if a terminal is capable of operating using several identities (e.g. associated with different user profiles), each identity under which the user terminal may operate may correspond to one user in the present context.

A profile is a collection of personal data and user-related information associated to a specific user, referring therefore to the explicit digital representation of a user's identity. For instance, user profiles can contain personal identifiable information such as name, address or email, the demographic elements that describe them (age, gender, . . . ), the groups they belong to, and other user-related information such as activities, pictures, likes/dislikes, interests, etc. other sets of information may be included in the definition of the user's profile, such as user behaviour inferred from previous actions and transactions, groups that the user has joined, dynamic context information, and so on.

The method improves and facilitates, notably by reducing the operational burden on the users, the selective distribution of information in computer or communication networks. It also provides a computer infrastructure to protect the privacy of the profiles of the users in the social networks. In that respect, the method assists the user in privacy management tasks. Privacy management, from a user's perspective, is the task consisting in controlling, by the user or to the benefit of the user, which data and protected resources (including his or her relations with other users, i.e. his or her “social graph”) maintained by a social network may be used by providers. The privacy management also includes the proper handling of the users' protected resources, consistent with the preferences of the user, for instance regarding the operations which can be performed in relation to the protected resources of a user.

These goals are met by letting a provider to propose, to the primary user, or to the terminal of the primary user, to provide information relating to the provider, such as information hosted by the provider, to the secondary users associated with the primary user. The provider can do so when the primary user, or his or her terminal, accesses the provider, that is, when there is an interaction between the terminal and the provider. At this occasion, the primary user is offered the opportunity to decide whether to accept the proposal of the provider. If the primary user, through his or her terminal, accepts the proposal, a message is transmitted by the provider to a controller having previously set a trust relationship with one or more social networks. The controller acts as a central point of interaction between a plurality of providers and a plurality of social networks.

The controller, upon receiving the message for the provider, transmits the information relating to the provider contained in or identified by the message to one or more social networks in which the primary user has a profile. This triggers the distribution of the information to the secondary users associated with the primary user, i.e. to the social network of the primary user.

In this manner, the primary user is not required to take the initiative of identifying information of potential interest to his or her online acquaintances, i.e. to the secondary users, to forward the information to them. The primary user is neither required to take the initiative of manually creating a message, such as an email or a modification to his or her social network profile (or any kind of messaging action), to forward the information to the secondary users. This also reduces the potential errors (e.g., regarding the web address of the information of interest) that the primary user may have made when creating a message intended to inform the secondary users about the identified information of potential interest.

This also enables providers of information, services and/or goods to suggest to primary users to consider forwarding information relating to the provider to the members of the social network of the primary user.

A message in the present context is a unit or units of information capable of being transmitted over a communication channel or over a network and capable of carrying or identifying information relating to the provider as well as associated parameters, if any. The message may include a media file including information originating from, and relating to, the provider or a uniform resource locator (URL) address pointing towards a media file.

Let us now return to the example described in the background section, i.e. the fictional exemplary situation involving the student moving to California, to help illustrating in a particular situation advantages provided by the invention.

The above-described example related to a student who, as part of a student exchange programme, moved to California, where there is a tsunami hazard zone (i.e., mainly the coastal region). Upon arriving, the visiting student receives an email from the host university prompting him or her to access the local university web portal and a page entitled “important information for visiting students”, itself containing a link to a document such as (for instance) http://www.conservation.ca.gov/cgs/geologic_hazards/Tsunami/Documents/TsunamiBrochure.pdf (as mentioned above). The student is therefore prompted to read important information explaining how to react in a situation involving a risk of tsunami.

Now, in an example of application of an embodiment of the invention, at one point in time (for instance when it is determined that the student has reached the end of the html or pdf page that he or she was reading, or when it is determined that the student has spent a certain lapse of time such as one minute reading the document, or when it is determined that the student has closed the document), the web site, such as for instance http://www.conservation.ca.gov, causes the student's browser to open a pop-up with the message: “Press OK to inform your social network that you read this document and found it a must to read for everybody planning to visit you” (where “your social network” means here the secondary users rather than all the users hosted in the social network). The student will most likely press on “OK” so that important, life-saving information on how to react to an earthquake in a tsunami-hazard zone will be disseminated, i.e. distributed, with the help and mediation of the controller according to an embodiment of the invention, acting as described above. The information will be distributed to a target group of people very likely to need to know this information in order to correctly react to a life-threatening situation. At the same time, the privacy of the personal data in the online social network to which the users participate is preserved, since the providers need to send messages to a controller having a trusted relationship with the social network(s) and, within the controller, suitable privacy-preserving mechanisms and filters may be implemented.

This example may also be applied to any other localized or temporary hazards, such as avalanches, mudslides, storms, wildfires, pickpocketings, or the like or other hazards such as scams, phishing, etc.

In one embodiment, the method is such that the proposal to provide information relating to the provider at least to some or all secondary users associated with the primary user in the at least one social network is a proposal to provide information relating to at least one of (i) the access by the terminal of the primary user to the provider, (ii) the relation between primary user and the provider, and (iii) the interest of the primary user in the information, services and/or goods presented and/or offered by the provider.

The provision of such particular information advertising a particular link between the primary user and the provider may accompany or constitute advertising a service or goods offered for sale by the provider. In one embodiment, the information relating to the provider is advertisement information relating to goods or services of the provider. In the particular field of advertisement (to which the invention is not limited), since users typically trust more their friends' recommendations than brands advertisements, the controller provides an advantageous method for user-centric, non-disruptive advertisement.

In one embodiment, the method further includes a step of setting up a trust relationship between the controller and the provider.

In one embodiment, the method is such that transmitting, by the provider to the controller, a message including or identifying the information relating to the provider is carried out by redirection of a browser running on the terminal of the primary user.

Such type of transmission of a message by the provider to the controller through a browser controlled by the primary user enables the primary user to provide confidential information identifying the primary user or enabling an access to the profile of the primary user within the social network to the controller, without sharing or providing this confidential information to the provider. The primary user may also modify, add or delete, in one embodiment, the information sent by the provider to the controller, in order to exercise some initial filtering on what the provider sends to the controller. In that embodiment, the message transmitted by the provider to the controller may be required to transit through the terminal of the primary user.

In one embodiment, the method is such that transmitting, by the provider to the controller, a message including or identifying the information relating to the provider further includes transmitting, by the provider to the controller, at least one of: (i) information about the at least one social network to which the information relating to the provider is to be transmitted; (ii) information about the secondary users associated with the primary user in the at least one social network to whom the information relating to the provider is to be transmitted; and (iii) at least one condition to be met for the information relating to the provider to be transmitted at least to some or all secondary users associated with the primary user in the at least one social network.

The transmission of such information to the controller enables the controller to adapt the distribution of the information to the secondary users as a function of the information type and content and the desires of the provider and the primary user.

In one embodiment, the method further includes, before triggering, by the controller, the transmission, to some or all secondary users associated with the primary user in the at least one social network, of the information relating to the provider, the following step: requesting, by the controller to the terminal of the primary user, and transmitting, by the terminal of the primary user to the controller, at least one of: (i) information about the at least one social network to which the information relating to the provider is to be transmitted; (ii) information about the secondary users associated with the primary user in the at least one social network to whom the information relating to the provider is to be transmitted; and (iii) at least one condition to be met for the information relating to the provider to be transmitted at least to some or all secondary users associated with the primary user in the at least one social network.

In one embodiment, the method is such that the at least one condition includes at least one of: (i) one or more conditions associated with the primary user, (ii) one or more conditions associated with the secondary users associated with the primary user, and (iii) one or more conditions associated with the at least one social network. In this embodiment, the method further includes, before triggering, by the controller, the transmission, to some or all secondary users associated with the primary user in the at least one social network, of the information relating to the provider, determining that the at least one condition is met.

If, on the contrary, the controller determines that the at least one condition is not satisfied in relation to the message received from the provider, the controller may decide not to trigger the transmission of the information relating to the provider to the secondary users. Alternatively, the controller may consult the primary user before triggering the transmission. The controller may also restrict the scope of the transmission of the information relating to the provider, for instance by limiting to which secondary users the information is transmitted.

The one or more conditions associated with the primary user and one or more conditions associated with the secondary users may include conditions relating to protected resources of the user in a social network. In this context, a protected resource is data related to a user's identity of a user or group of identities associated with a group of users. Examples of protected resources include private photos, lists of friends in the online social network, lists of bookmarks, lists of favourite songs stored in the online social network profile, lists of goods recently purchased from an online store associated with the online social network, etc. A protected resource may therefore include protected social information. Therefore, the controller may distribute the information based on determinations made on the protected resources of the secondary users.

For instance, if the information relating to the provider includes advertising a particular relation between the primary user and a web site offering for sale the download of horror movies, the controller may check the age of each of the secondary users (the age being a protected resource in this context) and may subject the transmission of the information to the age. Additionally, the controller may also check, in the list of favourite movies stored in the online social network profiles of each of the secondary users, whether there is any sign that the secondary user is interested in horror movies. The controller may then subject the distribution of the information to the presence of such signs.

In a sub-embodiment of the embodiment just described, the method further includes, before determining that the at least one condition is met, obtaining, by the controller, information regarding at least one of (i) the primary user in each of the at least one social network, and (ii) the primary user's social graph in each of the at least one social network, wherein a user's social graph includes the associations between the user and other users in a social network.

In one embodiment, the method is such that triggering, by the controller, the transmission, to some or all secondary users associated with the primary user in the at least one social network, of the information relating to the provider includes transmitting, by the controller to the at least one social network, a message causing the profile of the primary user in each of the at least one social network to be modified, and the modification to the profile of the primary user to be notified to the some or all secondary users associated with the primary user in the at least one social network.

In one embodiment, the method further includes: recording, by the controller, upon receiving a message transmitted from the provider, at least one of: (i) information regarding the provider from which the message originates; (ii) information regarding the primary user to whom the message relates; (iii) meta-information regarding the information identified or included in the message transmitted by the provider, such for instance the media type of the information, the size of the information, etc; (iv) information regarding conditions, if any, to be met for the information relating to the provider to be transmitted at least to some or all secondary users associated with the primary user in the at least one social network; (v) information regarding the at least one social network to which information relating to the provider is transmitted; (vi) information regarding the secondary users to whom information relating to the provider is triggered to be transmitted; and (vii) information regarding the time when information relating to the provider is triggered to be transmitted.

This embodiment enables tracking and reporting of the operations performed by the controller. Thus, providers as well as users may assess the amount, timing and type of information that has been transmitted to secondary users, or that has been prevented from being transmitted. This also enables the provider and the users to adapt, or to request adaptation of, the actions of the controller, to improve or adjust the selectivity of the distribution of the information. Additionally, the effectiveness of the controller for all the actors involved can be measured, thus providing valuable information to the users and operators of the method.

In one embodiment, a controller includes a setup unit, a receiver, an obtainer and a triggerer. The setup unit is configured for setting up a trust relationship between the controller and at least one social network. In this context, each of the at least one social network is at least one of a software application and a web site that is at least configured to maintain profiles of at least a user, here referred to as primary user, the primary user having a terminal, and other users, here referred to as secondary users, who are associated with the primary user in the at least one social network. The receiver is configured for receiving, from a provider, a message including or identifying information relating to the provider. In this context, the provider is at least one of a software application and a web site that is at least configured to present and/or offer information, services and/or goods to users. The obtainer is configured for obtaining identification of the primary user to whom the message relates. The triggerer is configured for triggering the transmission, to some or all secondary users associated with the primary user in the at least one social network, of the information relating to the provider.

In one embodiment, a system includes a controller as described above, at least one social network, a provider, and a terminal of a user, here referred to as primary user, wherein each of the at least one social network includes a setup unit configured for setting up a trust relationship with the controller; the terminal of the primary user includes an access unit configured for accessing the provider; the provider includes a first sender unit for sending, to the terminal of the primary user, a proposal to provide information relating to the provider at least to some or all secondary users associated with the primary user in the at least one social network; the terminal of the primary user further includes an accepter configured for accepting the proposal; the provider includes a second sender unit configured for sending a message including or identifying the information relating to the provider.

The system is not limited to one controller, one provider and one terminal. A plurality of controllers, a plurality of providers and a plurality of terminals of users may constitute the system.

In one embodiment, a computer program comprises instructions configured, when executed on a computer, to cause the computer to act as a controller as described above.

### BRIEF DESCRIPTION OF THE DRAWINGS

Embodiments of the present invention shall now be described, in conjunction with the appended figures, in which:

FIG. 1 is a flowchart of a method in one embodiment of the invention, schematically illustrating the distribution of information to secondary users in one social network;

FIG. 2 is a flowchart of a method in one embodiment of the invention, schematically illustrating the distribution of information to secondary users in a plurality of social networks;

FIG. 3 is a flowchart of a method in one embodiment of the invention, with in particular a step of setting up of a trust relationship between a controller and a provider;

FIG. 4 is a flowchart of a method in one embodiment of the invention, wherein the transmission of the message from a provider to the controller uses a redirection of the browser running on the primary user's terminal;

FIG. 5 is a flowchart of a method in one embodiment of the invention, including in particular a step of determining, by the controller, that one or more conditions are met before triggering the distribution of information to secondary users;

FIG. 6a is a flowchart of a method in one embodiment of the invention, wherein in particular the controller requests information from the primary user's terminal before triggering distribution of information to secondary users;

FIG. 6b is a flowchart of a portion of a method in one embodiment of the invention;

FIG. 7 is a flowchart of a method in one embodiment of the invention, wherein in particular, after requesting information to the primary user's terminal, the controller determines that one or more conditions are met before triggering distribution of information to secondary users;

FIG. 8 is a flowchart of a method in one embodiment of the invention, wherein in particular the controller obtains information from the social network before triggering distribution of information to the secondary users;

FIG. 9 schematically illustrates a controller in one embodiment of the invention;

FIG. 10 schematically illustrates a controller in one embodiment of the invention, including in particular a setup unit for setting up a trust relationship with a provider;

FIG. 11 schematically illustrates a controller in one embodiment of the invention, wherein in particular a requestor and a second receiver are provided for requesting and receiving information from the primary user's terminal;

FIG. 12 schematically illustrates a controller in one embodiment of the invention, wherein in particular a second obtainer is provided for obtaining information from the social network and wherein a determiner is provided for determining whether one or more conditions are met;

FIG. 13 schematically illustrates a controller in one embodiment of the invention, including in particular a recorder for recording and/or tracking the operations of the controller;

FIG. 14 schematically illustrates a system in one embodiment of the invention;

FIG. 15 schematically illustrates, in a particular technical field, the role of the controller mediating between the providers, the social network applications and the users, in one embodiment of the invention;

FIG. 16 is a flowchart of a method in one embodiment of the invention; and

FIG. 17 schematically illustrates the use of the OAuth protocol in one embodiment of the invention.

### DETAILED DESCRIPTION

The present invention shall now be described in conjunction with specific embodiments. These specific embodiments serve to provide the skilled person with a better understanding, but are not intended to in any way restrict the scope of the invention, which is defined by the appended claims.

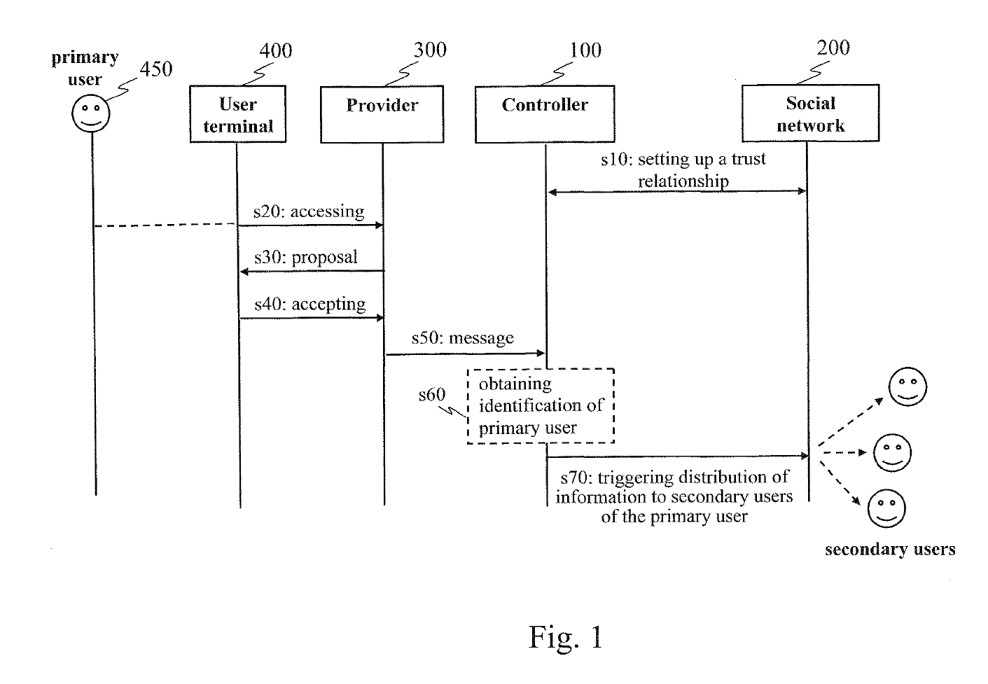

FIG. 1 is a flowchart of a method in one embodiment of the invention.

First, the trust relationship is set up s10 between the controller 100 and the social network 200. This step s10 of setting a trust relationship may include providing sufficient authorizations, notably in terms of computer access, to the controller 100 to enable it to query and more generally to interact with the particular social network 200. The setting up s10 of the trust relationship may also include providing from the controller 100 to the social network 200 guarantees that the accessing interfaces offered by the social network 200 to the controller 100 will be used in compliance with some agreed privacy conditions.

The controller 100 may be maintained by a telecom operator or by a group of companies owning and/or managing social network services. The invention is not limited in that respect.

Then, when the terminal 400 of a primary user 450 is used to access s20 a provider 300, the provider 300 proposes s30 to the terminal 400 of the primary user 450 to provide information relating to the provider 300 at least to some or all secondary users associated with the primary user 400 in the at least one social network 200. Accessing s20 the provider 300 by the user terminal 400 may for instance include sending, by the user terminal 400, an HTTP request to a web server of the provider 300. The proposal s30 may be included within an HTTP response sent back from the provider 300 to the terminal 400.

The terminal 400 and the primary user 450 are then offered the opportunity to decide whether to accept the proposal of the provider 300. The decision of accepting or refusing the proposal may be carried out actively by the primary user 450. Alternatively, the decision may be performed automatically by the terminal 400 according to rules set in the terminal 400 or in a browser of the terminal 400.

If the decision is to accept the proposal of the provider 300, the user terminal 400 sends s40 a message indicating the acceptance of the proposal to the provider 300. The decision by the terminal 400, or by the primary user 450, may be based on the content of the proposal from the provider 300 and/or based on which provider 300 has made the proposal. The proposal may include a description of the information that is intended to be sent from the provider 300 to the secondary users. The decision may also be based on information regarding to which secondary users the provider 300 intends to send the information.

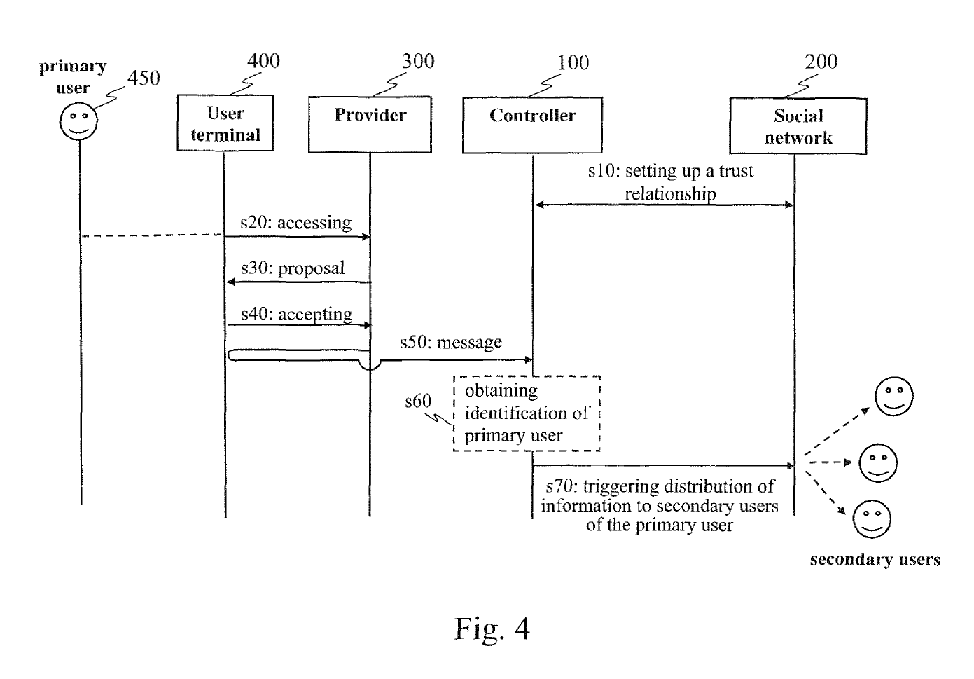

In reaction to receiving the acceptance message, the provider 300 sends s50 a message to the controller 100 with the information relating to the provider 300 to be distributed to the secondary users. Sending s50 the message from the provider 300 to the controller 100 may be carried out directly from the provider 300 to the controller 100 or, alternatively, may transit through the terminal 400, as will be explained later, notably in relation to FIG. 4.

The controller 100, having received a message from the provider 300, then obtains s60 identification of the primary user 450. The step of obtaining s60 identification of the primary user may include parsing the message received from the provider 300. Alternatively, if the message from the provider 300 has transited through the terminal 400, the controller 100 may obtain s60 identification of the primary user 450 from information regarding the origin of the message.

By obtaining s60, by the controller 100, identification of the primary user 450 to whom the message relates, it is meant that the controller 100 acquires sufficient information to identify the primary user 450 to whom the proposal has been made by the provider 300 and who has accepted the proposal. A matching between the identification of the primary user 450 as retrieved by the controller 100, or as obtained s60 by the controller 100, may be performed to identify the user profile corresponding to the primary user 450 in a particular social network 200. This may involve pre-configuring the controller 100 with such matching information. Alternatively, the obtained identification of the primary user 450 obtained s60 by the controller 100 may be sufficient to identify the user corresponding the primary user 450 in the social network 200. In one embodiment, the controller 100 communicates with the terminal 400 in order to obtain the identification of the primary user 450.

Thereafter, the controller 100 triggers s70 the distribution of information to secondary users of the primary user 450 in the social network 200. Triggering s70 may be carried out by the controller 100 by sending a message to the social network 200 to modify the profile of the primary user 450 in the social network 200. The modification of the profile of the primary user 450 is then also made known (propagated) to the secondary users thanks to the configuration of the social network 200.

In relation to the step s60 of obtaining, by the controller 100, identification of the primary user 450 to whom the message relates, the following remarks are made. User credentials of the primary user 450 in the social networks 200 do not have to be provided from the user side to the controller 100. User credentials of the primary user 450 in the social networks 200 are not required in the controller 100. It is here referred to primary user's 450 credentials (login, password, keys, . . . ) and not to the primary user's 450 identification.

In one embodiment of the invention, three different sets of primary user's 450 identities (identifications) may coexist:
1) User identity in a service provider 300. This will not be described in the present description, since this may have no direct impact on the invention.
2) User identity in the controller 100.
3) User identity in a social network 200.

The step s60 of obtaining may refer to any of the above identities, but the primary user's 450 identification by the controller 100 is required to enable the controller 100 to identify the primary user 450 to whom the message relates. Identification of the primary user 450 in the controller 100 can be carried out by different means, for example, by means of cookies or using a set of credentials.

On the other hand, some kind of identification of the primary user 450 in the social network 200 (identity number “3)”) is also required for the controller 100. In particular, triggering s70 the transmission of the information requires an identification of the primary user 450 in the social network 200. Different embodiments are possible.

In one embodiment, the OAuth/OpenSocial protocols are used to enable these messages. In accordance with OAuth procedures, which are based on user-agent (e.g., browser) redirections, resource owners are able to authorize third-party to access their resources, which are hosted by a hosting entity, without sharing their credentials at the hosting entity and even without releasing to the third party their real identity at the hosting entity. OAuth uses tokens generated by the hosting entity as user identification instead of the user's credentials in the requests for protected resources. As a result, it is possible for the controller 100 to obtain s60 information about the primary user 450 and to trigger s70 the transmission of the information without knowing the user credentials in a social network 200. It is enough for the controller 100 to know the token generated by the hosting entity for such user.

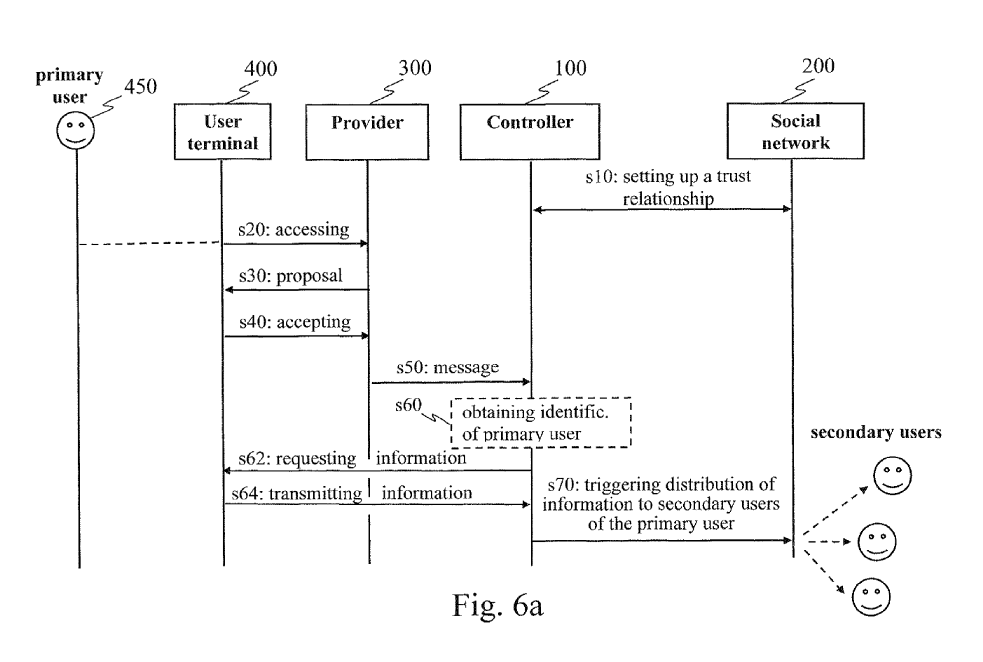

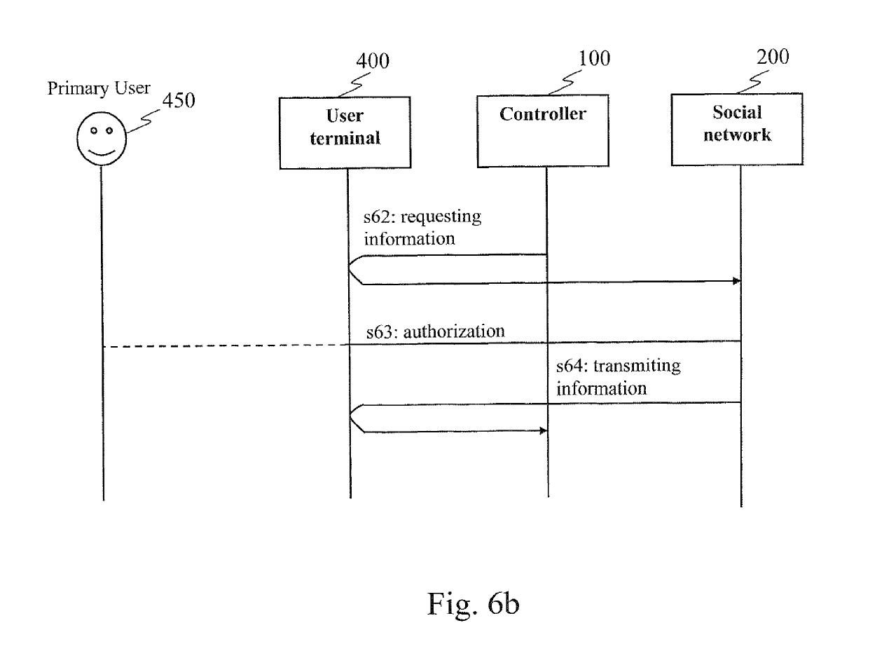

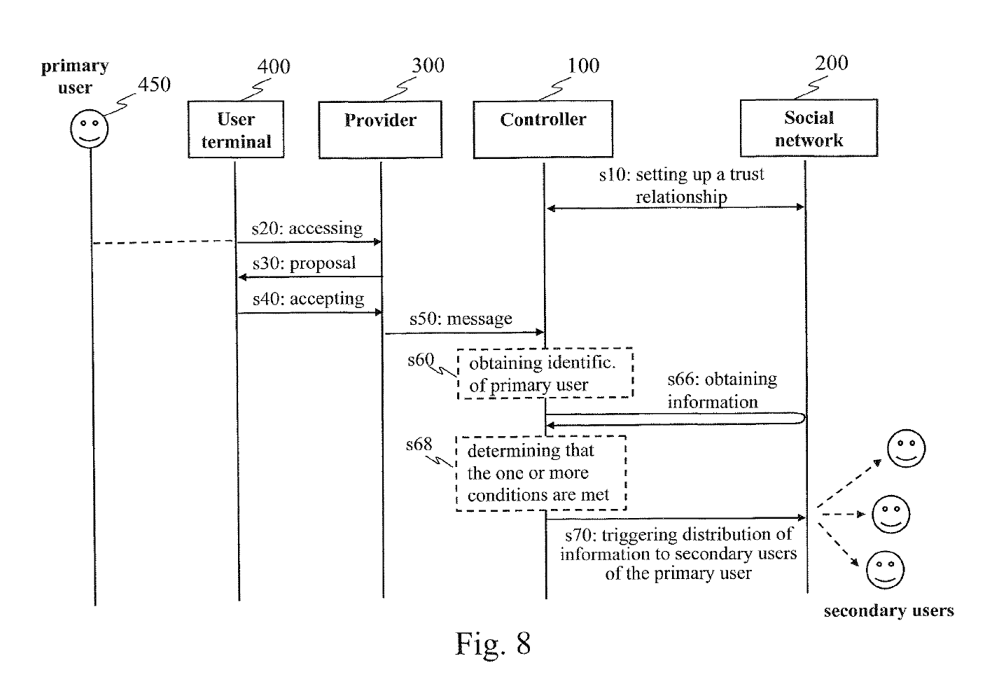

Steps s62 and s64, which will be described with reference to FIG. 6a, cover the use of the OAuth protocol (see also FIG. 6b), and thus provide the controller 100 with the required token to subsequently enable the step of triggering s70 (and in one embodiment the step s66 of obtaining, see FIG. 8) by means of OpenSocial protocol. The method includes requesting s62 and transmitting s64 information about the at least one social network 200. This information about the at least one social network 200 may include the token that the user terminal 400 has retrieved from the social network 200 as part of the OAuth protocol.

From the embodiment illustrated in FIG. 1, it can be seen that the providers 300 are provided with a central entity, the controller 100, with which to set up trust relationships for the distribution of information, such as distribution of warning information or advertisement information. Similarly, social networks 200 are provided with a central entity with which to set up trust relationships. This reduces the amount of agreements, interfaces and operative procedures that every party must set up for the distribution of information, such as in a campaign of distribution of warning information or in an advertising campaign. The providers 300 do not have to manage relationships with several social network providers. Conversely, social networks 200 do not have to manage a huge amount of relationships and agreements with providers 300.

The controller 100 may also anonymize users' identity towards the providers 300 so that their profile and social network information cannot be further used by the providers 300 once a transaction is completed. However, the controller 100 allows the providers 300 to define conditions upon which their information will be delivered.

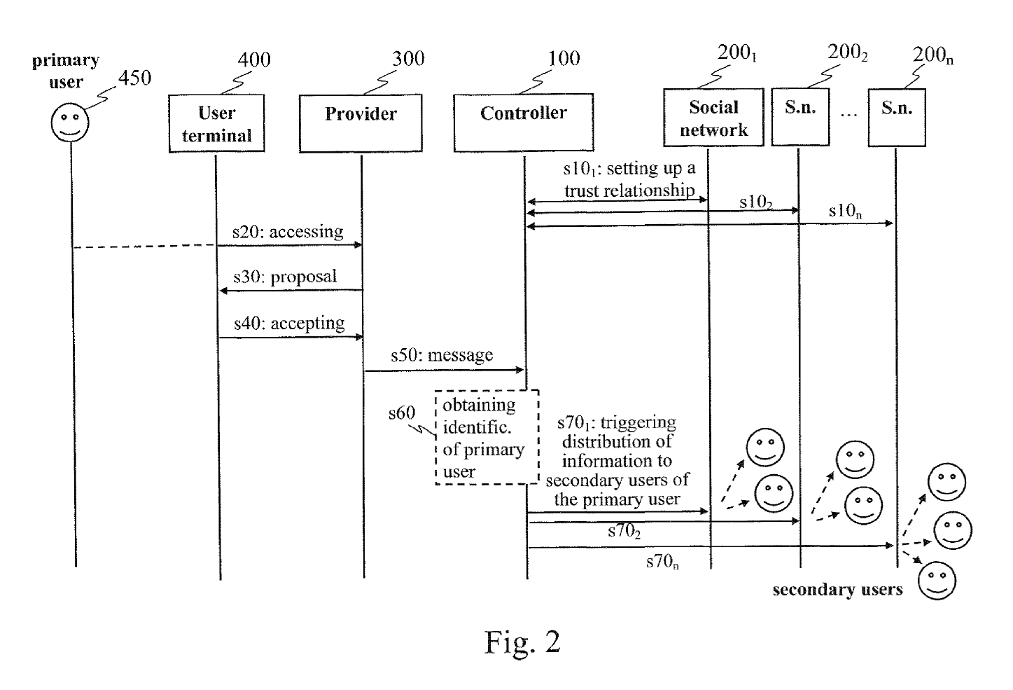

FIG. 2 is a flowchart of a method in one embodiment of the invention, which differs from the method illustrated in FIG. 1 in that a plurality of social networks 200₁, 200₂, . . . 200ₙ are provided. The controller 100 sets up s10₁, s10₂, . . . s10ₙ trust relationships with each of the social networks 200₁, 200₂, . . . 200ₙ. Furthermore, after receiving s50 a message including or identifying the information relating to the provider 300, the controller 100 obtains s60 identification of the primary user 450 and triggers s70₁, s70₂, . . . s70ₙ distribution of information of information to secondary users of the primary user 450 in each one of the social networks 200₂, 200₂, . . . 200ₙ.

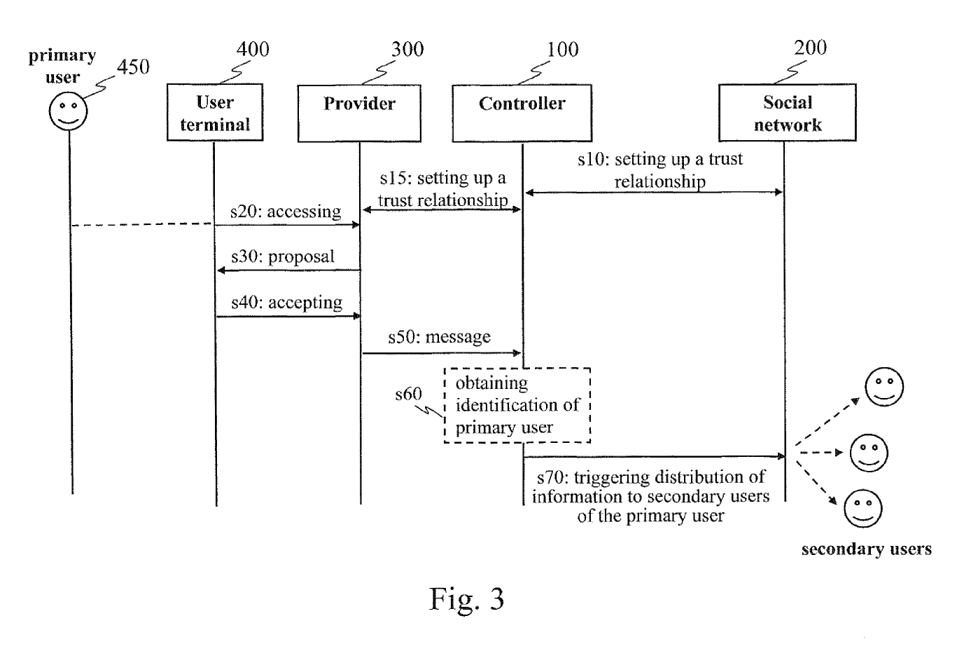

FIG. 3 is a flowchart of a method in one embodiment of the invention, which differs from the method illustrated in FIG. 1 in that a further step of setting up s15 a trust relationship between a provider 300 and the controller 100 is provided. The setting up s15 of a trust relationship between the provider 300 and the controller 100 further enables the prevention of any abuse against the user's privacy. The provider 300 may be given access to some functions of the controller 100 in such a manner to be able to send the message s50 to the controller 100, while complying with the format and content that the message should have in accordance with rules set up in the controller's 100 communication interface.

FIG. 4 is a flowchart of a method in one embodiment of the invention, which differs from the method illustrated in FIG. 1 as follows. The message transmitted from the provider 300 to the controller 100 is transmitted s50 by redirection of a browser running on the terminal 400 of the primary user 450.

The redirection may be based on the OAuth protocol. An explanatory introduction to the OAuth protocol is here provided to help understanding this particular implementation of this embodiment. Other implementations of this embodiment are possible however.

In computer or communication networks, different web sites or web applications may provide different services for the benefit of a user. For instance, one web site or web application may manage an email account of the user. Another web site or web application may enable the storage of photos for sharing them to members of a social network of the user. Yet another web site or web application may act as a bookshop managing a user's bookshop account. Yet a further web site or web application may offer to print images and photos and deliver them to users. The possibilities are endless. In the present context, a web site or web application is constituted by a provider 300, another web site or web application may be constituted by a controller 100, and yet another web site or web application may be constituted by a social network 200.

Yet, web sites and web applications may want to offer services “which tie together functionality from other sites” (Eran Hammer-Lahav, “Explaining OAuth”, Sep. 5, 2007, http://hueniverse.com/2007/09/explaining-oauth/—retrieved on Sep. 15, 2009, here referred to as ref. [1]). For instance, a digital photo lab printing web application (such as an exemplary web site “printer.consumer.com”) may want to retrieve, on behalf of a user, photos stored in a digital image hosting web site (such as an exemplary site “photos.container.com”) with which the user has an account, in order to print and deliver these photos to the user. Or, in the present context, a provider 300 (the provider 300 constituting a first web site or software application) may wish to propose s30 to a terminal 400 of a primary user 450 to provide information relating to the provider 300 to the secondary users (the social network 200 constituting a second web site or software application).

In order to implement a web service integrating protected resources from different web sites and web applications, a first web site or web application, here referred to as the “consumer”, may request the user to provide his or her credentials to access a second web site or web application, here referred to as the “service provider” (although the consumer also provides services). In the above-mentioned example, the consumer would be the digital photo lab printing web application, the service provider would be the digital image hosting web site, and the protected resources would be the user's private photos. In other words, the consumer may request the user to provide his or her username and password to access the service provider. This, however, exposes the user's password and enables the password to be used by someone else for any actions associated with the user's account within the service provider (such as “even change your password and lock you out”, ref. [1], section “What is it For”).

To solve that problem, the OAuth protocol has been developed (Atwood, M. et al, “OAuth Core 1.0 Revision A”, Jun. 24, 2009, http://oauth.net/core/1.0a—retrieved on Jun. 29, 2010, here referred to as ref. [2]). The OAuth protocol enables a web site or web application, i.e. the consumer, to access protected resources from another web site or web application, i.e. the service provider, without requiring the users to disclose their service provider credentials to the consumers (ref. [2], Abstract). The OAuth protocol may be viewed as an application programming interface (API) access delegation protocol. The valet key analogy, explained in ref. [1], section “What is it For”, may help to intuitively understand the purpose of the OAuth protocol.

In the OAuth protocol, the authentication, i.e. “the process in which users grant access to their protected resources without sharing their credentials with the consumer” (ref. [2], “6. Authenticating with OAuth”), works as follows.

The consumer obtains an unauthorized request token from the service provider. The consumer directs the user to the service provider via the user's web browser, using the service provider's user authorization URL (“URL” stands here for “Uniform Resource Locator”). The user then authenticates him- or herself with the service provider. In other words, the user signs into the service provider's web site. At no time the user provides his or her service provider credentials to the consumer.

The service provider then asks the user whether he or she agrees with the consumer being granted access to the protected resources. To do so, the service provider presents, to the user, information about the protected resources to which the consumer wants to access. The information includes the duration of requested access and the type of access (e.g. copy, modify, or delete a protected resource). The information may for instance be presented on a web page of the service provider web site with an exemplary message such as “The web site <consumer-name> is requesting access to your private photos for the next 1 hour. Do you approve such access?” The user then grants or denies permission for the service provider to give to the consumer the envisaged access on behalf of the user.

If the user agrees, the request token is authorized and the user is directed back to the consumer, so that the consumer is notified that the request token has been authorized. The authorized request token is then exchanged for an access token and the protected resources can be accessed by the consumer on behalf of the user. If the user denies permission, the consumer is notified that the request token has been revoked.

An example of authentication process using the OAuth protocol is presented in Eran Hammer-Lahav, “Beginner's Guide to OAuth—Part II: Protocol. Workflow”, Oct. 15, 2007, http://hueniverse.com/2007/10/beginners-guide-to-oauth-part-ii-protocol-workflow/—retrieved on Sep. 15, 2009.

In accordance with the OAuth protocol, privacy management is handled by users themselves. Users authorize consumers to access protected resources of a service provider. Once the authorization is given, the consumer gets an access token to access to the protected resources.

The same redirection mechanism as used in the OAuth mechanism may be used in the embodiment of the method illustrated in FIG. 4, involving the user terminal 400 (also user in the OAuth protocol), the provider 300 (acting as consumer in the OAuth protocol) and the controller 100 (acting as service provider in the OAuth protocol). It will be also seen (notably with reference to FIG. 6b) that the OAuth mechanism may be used in relation to the communication between the user terminal 400 (also user in the OAuth protocol), the provider 300 and controller 100 (both acting as consumer in the OAuth protocol) and the social network 200 (acting as service provider in the OAuth protocol).

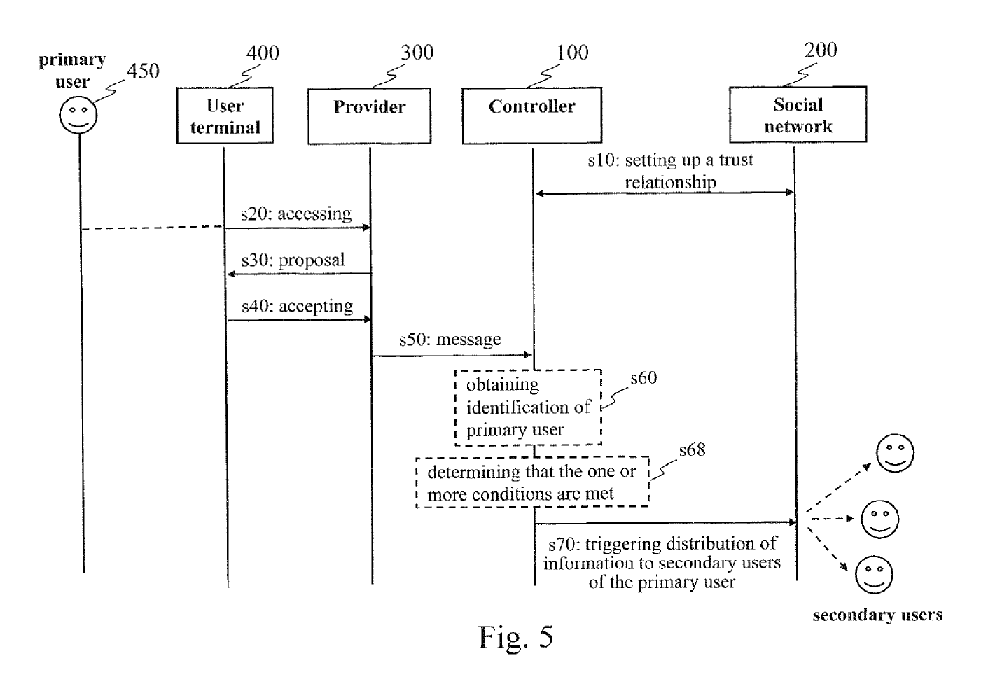

FIG. 5 is a flowchart of a method in one embodiment of the invention, which differs from the method illustrated in FIG. 1 as follows. When the provider 300 transmits s50 the message to the controller 100, further information is transmitted by the provider 300 to the controller 100 (either in the same message or in another message).

The provider 300 may notably transmit information about the at least one social network 200 to which the information relating to the provider 300 is to be transmitted. This enables to restrict the distribution of information to some social networks 200.

The additional information transmitted by the provider 300 to the controller 100 may alternatively also include information about the secondary users to whom the information relating to the provider 300 is to be transmitted. This enables the controller 100 to trigger s70 distribution of information to only some secondary users of the primary user 450.

The additional information transmitted by the provider 300 to the controller 100 may also include at least one condition to be met for the information relating to the provider 300 to be transmitted to the secondary users. The at least one condition may be one or more conditions relating to the primary user 450, relating to the secondary users associated with the primary user 450, or relating to the at least one social network 200.

The controller 100 determines s68 whether the one or more conditions are met, and, if so, the controller 100 triggers s70 the distribution of information to the secondary users of the primary user 450.

FIG. 6a is a flowchart of a method in one embodiment of the invention, which differs from the method illustrated in FIG. 1 as follows. After obtaining 960 identification of the primary user 450, the controller 100 requests s62 information from the user terminal 400. The terminal 400 then transmits s64 information back to the controller 100. The requested information may be information about the at least one social network 200 to which the information relating to the provider 300 is to be transmitted. The information may also be about the secondary users to whom the information relating to the provider 300 is to be transmitted. Furthermore, the information may include that at least one condition to be met for the information relating to the provider 300 to be transmitted by the controller 100 to the secondary users.

Steps s62 and s64 may also be carried out to obtain information from the primary user 450 to be able to identify the correct profile of the primary user 450 in the social network 200. In that case, steps s62 and s64 may also take place simultaneously to step s60. In one embodiment, steps s50, s62, 364, s66 and s70 may make use of the OAuth protocol, as follows. The primary user 450 should be identifiable at the social network 200 and the controller 100 should have some way to refer to such primary user 450 when interacting with the social network 200. OAuth provides the means to support these requirements. The flow of messages for OAuth 1.0 may, in one embodiment, be as follows:

1) A primary user 450, or the terminal 400, accesses the controller 100. At this point in time, the controller 100 does not know the primary user identity, credentials or identifier at the social network 200.
2) The controller 100 asks for a token to the social network 200.
3) The social network 200 sends a token to the controller 100. The token is unauthorized at this stage.
4) The controller 100 redirects the primary user 450, or the terminal 400 browser, to the given social network 200, including the unauthorized token obtained in step “3)” as part of the message. Redirections may be HTTP redirections.
5) The social network 200 requires the primary user 450 his or her credentials at the social network 200 and stores the received token. The social network 200 informs the primary user 450 that, by entering the credentials, the primary user 450 is authorizing the social network 200 to retrieve information on his behalf.
6) The primary user 450 provides the social network 200 with the required credentials.
7) The social network 200 identifies the primary user 450 using the credentials provided. If the primary user 450 is successfully authenticated, the social network 200 marks the token received in “5)” as authorized. The social network 200 sends the authorized token back to the controller 100, by means of HTTP redirections.
8) The controller 100 receives the authorized token. This token allows identifying the primary user 450 at the social network 200.
9) The controller 100 sends a message to the social network 200 to exchange the authorized token by an access token. The access token allows the controller 100 to retrieve primary user information (primary user protected resources) from the social network 200 on behalf of the primary user 450.
10) The social network 200 checks that the token received in “9)” is really authorized. If authorized, the social network 200 sends an access token back to the controller 100.
11) The controller 100 receives the access token.
12) The controller 100 uses the access token to get/set primary user information from/to the social network 200.

OAuth 2.0 may reduce the amount of required messages and complexity of steps involved, and thus steps “2)” and “3)” may not be required. The messages in both protocols OAuth 1.0 and 2.0 are not exactly the same, and thus, the above steps 1) to 12) provided for OAuth 1.0 may be different for OAuth 2.0. For instance, OAuth 2.0 does not require the controller 100 to ask for a request token to the social network 200 (above steps 2 and 3 are not required) and thus, step 4 would not require sending the token.

Therefore, messages s50, s62, s64, s66 and s70 as illustrated in FIG. 6a cover the described process. The equivalence of messages as follows:
Message “1)” of the OAuth flow==s50
Message “4)” of the OAuth flow==s62
Messages “5)”, “6)”, “7)” are out of the scope of the present description
Message “8)” of the OAuth flow==s64
Message “9)”, “10)” and “11)” of the OAuth flow==s66
Message “12)”==s66 and s70

If OAuth 1.0 is implemented, above steps 2) and 3) are carried out. These steps 2) and 3) are not illustrated in the drawings. On the other hand, if OAuth 2.0 is used (E. Hammer-Lahav et al, “The OAuth 2.0 Protocol, draft-ietf-oauth-v2-09”, Internet-Draft, Network Working Group, retrieved on. Jun. 29, 2010 from http://tools.ietf.org/html/draft-ietf-oauth-v2-09, section 1.4.1, Web Server) steps 2) and 3) are not required. The drawings illustrate such interactions, namely the absence of steps 2) and 3).

FIG. 6b also shows details of such method, including the authorization step s63.

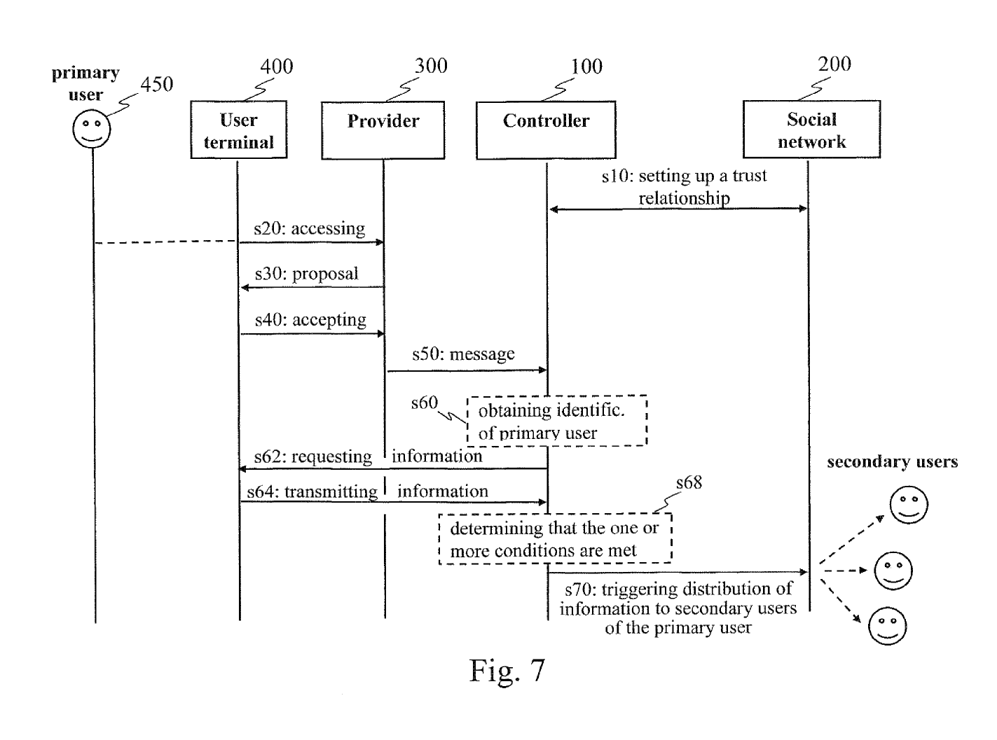

FIG. 7 is a flowchart of a method in one embodiment of the invention, which differs from the method illustrated in FIG. 6a as follows. After receiving s64 information from the terminal 400 (information which in this embodiment includes one or more conditions), the controller 100 determines whether the one or more conditions are met s68. If so, the controller 100 triggers 870 distribution of information to secondary users of the primary user 450.

FIG. 8 is a flowchart of a method in one embodiment of the invention, wherein the controller 100, after obtaining s60 identification of the primary user 450, obtains s66 information from the social network 200. Based on the obtained information, the controller 100 determines s68 whether one or more conditions are met. If so, the distribution of information to secondary users of the primary user 450 is triggered s70. The one or more conditions may have been received with the message sent in step s50 or may have been received by the controller 100, upon request, from the user terminal 400 (see in that respect FIG. 6a).

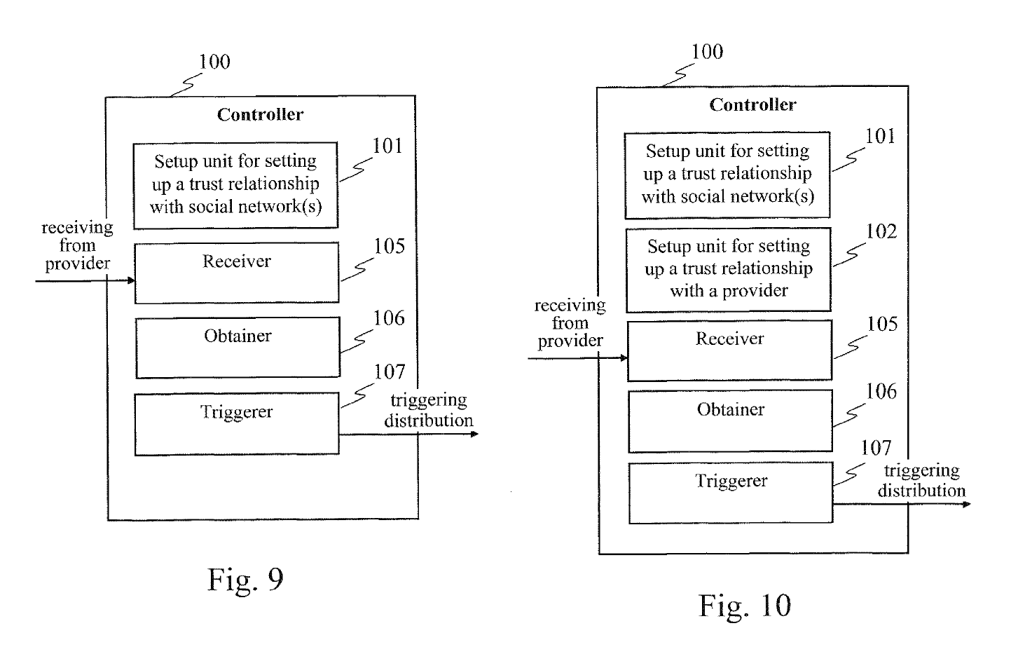

FIG. 9 schematically illustrates a controller 100, and some of its constituent elements, in one embodiment of the invention. The controller 100 includes a setup unit 101, a receiver 105, an obtainer 106 and a triggerer 107.

The setup unit 101 is configured for setting up a trust relationship between the controller 100 and at least one social network 200. The receiver 105 is configured for receiving, from a provider 300, a message including or identifying information relating to the provider 300 (the information to be distributed). The arrow labelled “receiving from provider” shown in FIG. 9 and reaching the receiver 105 from the left-hand side illustrates the function of the receiver 105 to receive the message from the provider 300.

The obtainer 106 is configured for obtaining identification of the primary user 450 to whom the message relates. The obtainer 106 may be configured for parsing the message received by the receiver 105 from the provider 300, for detecting from which terminal 400 the message has transited when being transmitted from the provider 300 to the controller 100 (if the message is transmitted in this manner), or for detecting from which terminal 400 the message has transited and requesting thereafter further identification information from the terminal 400.

The triggerer 107 is configured for triggering the transmission, to some or all secondary users associated with the primary user 450 in the at least one social network 200, of the information relating to the provider 300. The arrow labelled “triggering distribution” shown in FIG. 9 and originating from the triggerer 107 schematically illustrates the function of the triggerer 107 to trigger distribution of the information to the secondary users.

FIG. 10 schematically illustrates a controller 100 in one embodiment of the invention, which differs from the controller 100 illustrated in FIG. 9 as follows. The controller 100 further includes a second setup unit 102 for setting up a trust relationship with a provider 300.

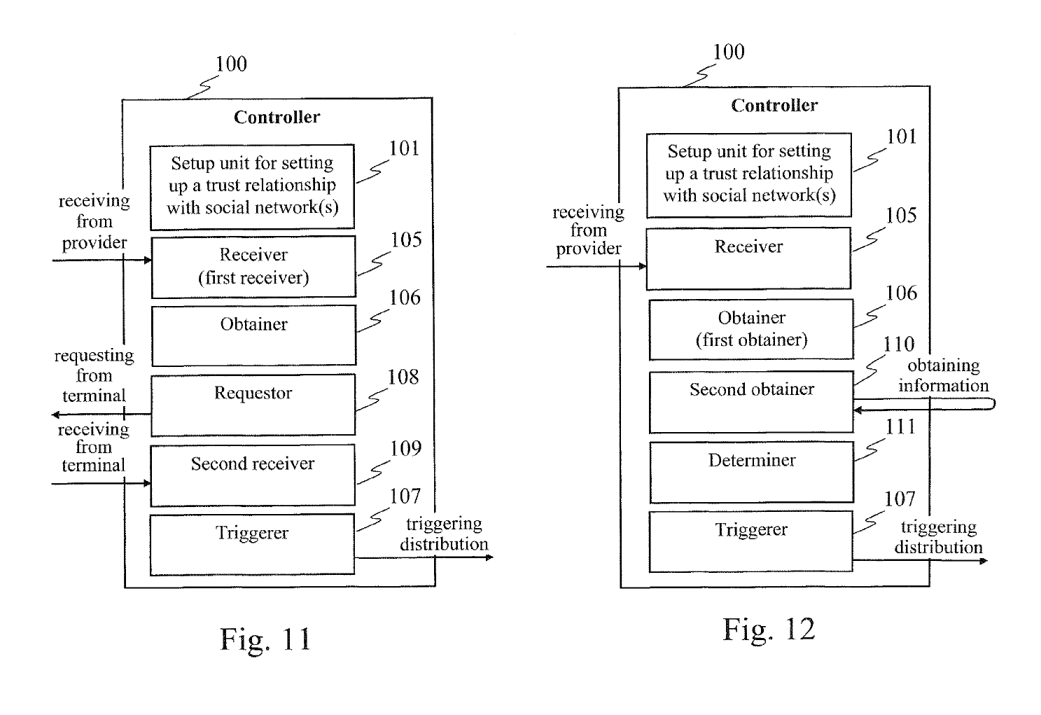

FIG. 11 schematically illustrates a controller 100 in one embodiment of the invention, which differs from the controller 100 illustrated in FIG. 9 in that it further includes a requestor 108 and a second receiver 109.

The requestor 108 is configured for requesting, to the terminal 400 of the primary user 450, additional information. The second receiver 109 is configured for receiving, from the terminal 400 of the primary user 450, the requested additional information. The additional information may include at least one of: (i) information about the at least one social network 200 to which the information relating to the provider 300 is to be transmitted; (ii) information about the secondary users associated with the primary user 450 in the at least one social network 200 to whom the information relating to the provider 300 is to be transmitted; and (iii) at least one condition to be met for the information relating to the provider 300 to be transmitted at least to some or all secondary users associated with the primary user 450 in the at least one social network 200.

FIG. 12 illustrates a further embodiment of a controller 100 in one embodiment of the invention, wherein information is configured to be obtained by a second obtainer 110. The second obtainer 110 is configured for obtaining the information from the social network 200. Based on the obtained information, a determiner 111 determines whether conditions are met for allowing the triggerer 107 to carry out these actions or not.

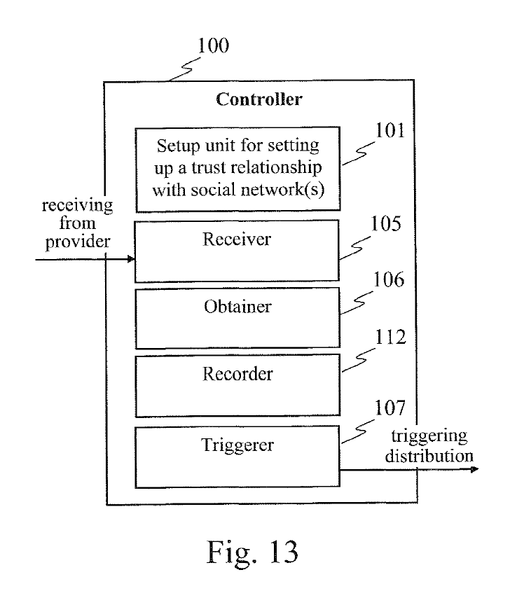

FIG. 13 schematically illustrates a controller 100 in one embodiment of the invention, including a recorder 112 to record and track various information regarding the activities and operations of the controller 100. The controller 100 may thereafter provide the recorded information to interested parties.

Recording information regarding the operation of the controller 100, i.e. recording information about an information distribution campaign, such as but not only an advertising campaign, may be performed by the recorder 112.

When a provider 300 carries out an information distribution campaign, such as an advertising campaign, using the controller 100, it is useful to measure its effectiveness. As a way of example, one indicator of the effectiveness of a campaign might be the number of viewers who, following the distribution of information by the controller 100, have ended up at the provider 300 site. Other indicators may be provided either regarding a provider 300, an information distribution campaign, such as an advertising campaign, a user, a user's profile, a user's social graph, a social network 200, or combinations thereof.

The recorded information may include details about the distributed piece of information or advertisement instance, the provider 300, the user and the social networks 200, such as:
0. Information distribution or advertisement ID: An identifier that uniquely refers to one piece of information or advertisement instance distributed by one provider 300, and associated to one user in one social network 200;
1. The provider 300 that requested the distribution of a piece of information, such as advertisement;
2. The information and meta-information (media type, size, etc.) regarding the piece of information, such as the advertisement;
3. The conditions set on the distribution;
4. The user that disseminates the piece of information, such as the advertisement, to his/her associated secondary users;
5. The social network 200 to which the piece of information, such as the advertisement, is distributed;
6. The social graph to which the piece of information, such as the advertisement, is distributed;
7. The timestamp of the distribution;
8. The outcome of the distribution process;

In addition, the recorded information may include details regarding the success of the distribution of the information, such as advertisement information, such as, but not limited to:
9. The number of times a piece of information, such as an advertisement, has been shown;
10. The number of times the piece of information, such as the advertisement, has been clicked through;
11. The timestamp of events numbered as 9 and 10.

The recording may be carried out by the controller 100 at different times. Information numbered from 1 to 4 may be recorded after step 50 (FIG. 1). Information numbered as 5 (social network-related information) may be recorded after step 50, if the information is available. Otherwise, it may be recorded after step s64 (FIG. 6a). Information numbered from 6 to 8 is recorded after step s70 (FIG. 1) has been completed for each social network 200.

Information numbered from 9 to 11 is recorded when the controller 100 receives the information, as follows. Events that generate the information labelled as “9” are generated by the social network 200 to which the advertisement has been delivered. In addition, events that generate the information labelled as 10 are generated by the users at the social network 200 to which the advertisement has been delivered. The controller 100 may receive notification of these events.

In one embodiment, the controller 100, after step s50 (FIG. 1), modifies the piece of information, or advertisement information, to introduce two computer program code snippets. The first computer program code requires for its rendering in the user user-agent some information from the controller domain. As a way of example, the controller may introduce a piece of HTML code that accesses a URL on the controller domain, namely the exemplary osam.com domain, (possibly a 1 pixel image):
<img src=“http://osam.com/pix.gif?id=123456789”/>.

This results on an invocation to the controller 100 indicating that the advertisement instance identified by the advertisement ID has been rendered to a viewer. Therefore, at this moment, the controller 100 records the display of a specific advertisement to a viewer. Similarly, the controller 100 modifies the piece of information, such as an advertisement, to introduce a second piece of computer program code. This piece of computer program code redirects the information or advertisement viewer browser to the controller 100 when the viewer clicks on the piece of information or advertisement.

For instance, a piece of information or advertisement delivered to a first user's social network 200 may be modified to introduce an HTML link e.g.
“I have an awesome new cellular. If you want another, click here (where ‘here’ is a hyperlink as for HTML linking to the controller domain and containing the advertisement ID).”

When a member of the first user's social network (the viewer) clicks on the link, his or her web browser redirects him or her to the controller 100, which records the event related to the advertisement ID. Once the relevant information has been recorded, the controller 100 redirects the viewer to the provider 300 where the primary user 450 bought the cellular.

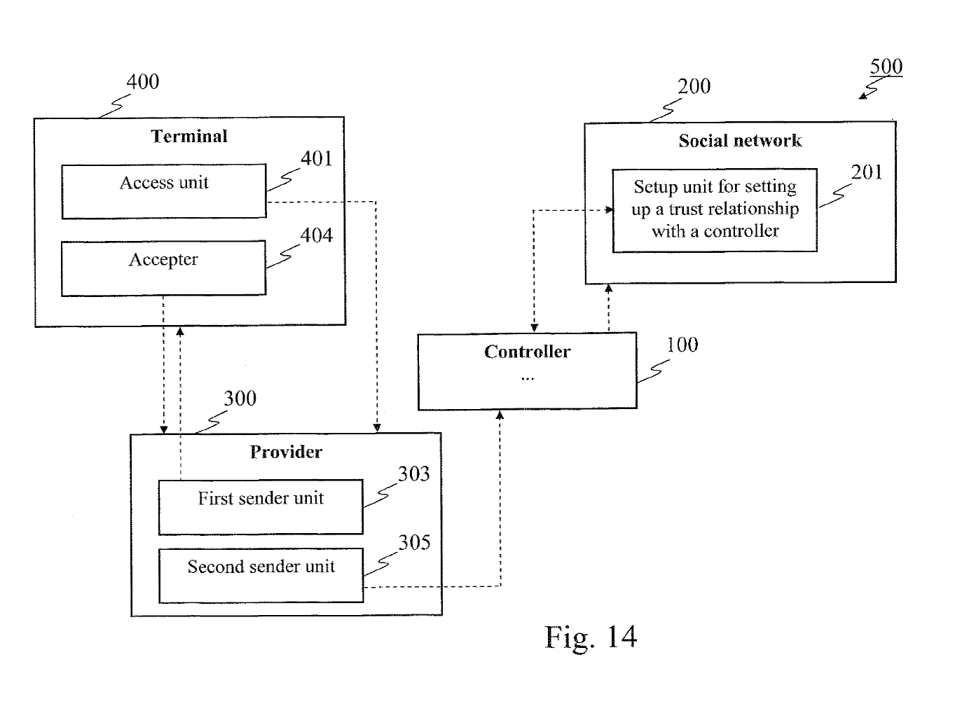

FIG. 14 schematically illustrates a system 500 in one embodiment of the invention. The system 500 includes a controller 100, a social network 200, a provider 300, and a terminal 400.

The controller 100 is as described in any of the above embodiments. The terminal 400 has an access unit 401 which is configured to access the provider 300 (as schematically illustrated by the dotted arrow from the access unit 401 leading to the provider 300). The provider 300 includes a first sender unit 303 which is configured for sending, to the terminal 400 (as schematically illustrated by the dotted arrow from the first sender unit 303 leading to the terminal 400), a proposal to provide information relating to the provider 300 to his or her associated secondary users. The terminal 400 further includes an accepter 404 configured for accepting the proposal sent by the first sender unit 303 of the provider 300, if the terminal 400, or the user 450 using the terminal 400, has determined that the proposal was acceptable (as schematically illustrated by the dotted arrow from the accepter 404 leading to the provider 300). The provider 300 further includes a second sender 305 configured for sending a message including or identifying the information relating to the provider 300. The second sender 305 is configured for sending the message to the controller 100 (as schematically illustrated by the dotted arrow from the second sender unit 305 leading to the controller 100).

Furthermore, the social network 200 includes a setup unit 201 for setting up a trust relationship with a controller 100 (as schematically illustrated by the bidirectional dotted arrow between the setup unit 201 and the controller 100). The dotted lines illustrated in FIG. 14 illustrate the interactions, or at least some of the interactions, that are configured to be carried out by the system 500 illustrated in FIG. 14.

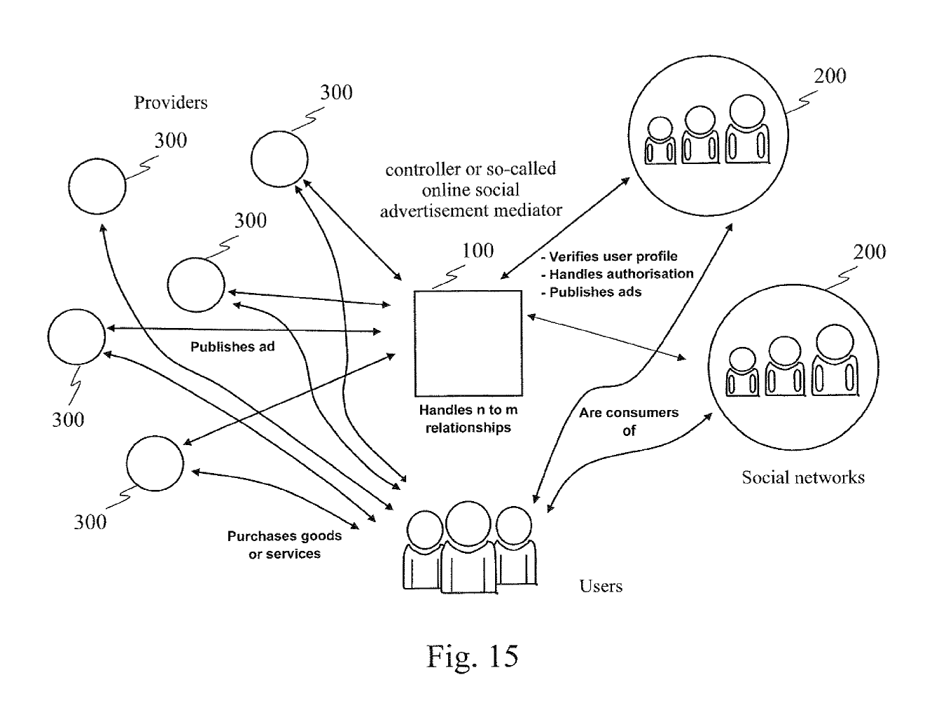

In one embodiment, as illustrated in FIG. 15, a new entity, the controller 100, which may be called in this embodiment an online social information distribution mediator (OSIDM) or online social advertisement mediator (OSAM), is provided. Methods are also provided for enabling word of mouth distribution of information, or, in a particular field, advertising, from a provider 300 to one or more social network 200 by interacting with the social network's users and their social graphs and profiles.

As illustrated in FIG. 15, three different entities are considered in this embodiment:

(i) A so-called provider 300. This entity notably presents and/or offers information, services and/or goods to users using electronic means.
(ii) A social network 200. In this entity, users enjoy a personal space that allows them to register a profile and (re)create their social network, communicating to and sharing with their social network members the information that this profile contains, and also receiving in their personal space news and updates regarding the members of their social network (i.e., regarding the secondary users).

In addition, in the embodiment illustrated in FIG. 15:

The social networks 200 allow the management (query, modification, deletion, etc) of profiles of their users by third parties outside the social network domain. This management process is usually enabled by means of an application programming interface (API), although other means are also possible. For instance, MySpace, a social network, allows third party management of users' profile by means of the OAuth and OpenSocial APIs and protocols. These protocols are explained elsewhere in the description, or are known to the skilled person.

When users of a social network 200, or third parties working on their behalf, update a piece of data of their profile, this event and the related information is communicated by the social network 200 to the personal spaces of some or all secondary users in the social network 200. For instance, when a user updates his/her profile at LinkedIn (a professional-oriented social network) by changing his/her picture or by joining an interest group, this information is communicated to the personal space of the members of the user's declared social network at LinkedIn. There are many ways through which the social network 200 may communicate the updates to the personal space of the members of the user's social network at the social network 200. The skilled person may select a suitable implementation.

(iii) The controller 100 which has been described above notably with reference to FIGS. 9 to 13.

Both the providers 300 and the social networks 200 maintain relationships with users.
Users obtain or purchase information, services and/or goods from providers 300. Users may have an account in such provider 300, but this is not directly relevant in the present context. On the other hand, providers 300 wish to deliver information, or, in a particular field, advertisements, to the members of the users' social network at one or more social networks 200, provided that a given set of conditions is fulfilled, for successful selective distribution without swamping users with information in which they may not be interested. The given user is online with the provider 300 so that she or he can be subsequently redirected to the controller 100, by means, for instance, of an HTTP redirect.
Users keep an account at one or more social networks 200. Each account includes at least a personal space which includes at least a profile and information about the user's social network relationships within the social network 200.

One of the functions of the controller 100 is to handle the relationships between n providers 300 and m social networks 200, so that the distribution of information or, in a particular field, of advertisements, by the provider 300 to the secondary users is simplified. To this end, the controller 100 establishes a trust relationship with such n providers 300 and m social networks 200, so that the controller 100 is able, in one embodiment, to:
Receive requests from trusted and identified providers 300 to deliver the information or, in a particular field, advertisements, to the members of a given user's social network at one or more social networks 200 provided that a set of conditions is fulfilled. Upon the reception of the request, the controller 100 creates an identifier that uniquely identifies the given pair of user and information to be distributed, or advertisement, and stores the related information.
Verify that the conditions set for the distribution of the information, or, in a particular field, of the advertisement, are fulfilled. To this end, the controller 100 retrieves information from the user's profile and social graph at the social networks 200 and checks it against the conditions.
Distribute the information, or, in a particular field, the advertisement, to the secondary users by updating the user's profiles at the social networks 200.
To handle authorization against the social network 200 for the two previous operations.

Therefore, in one embodiment, three procedures are carried out:
A first one where the controller 100 sets up a trust relationship with a social network 200. This process can be extended to any number of social networks.
A second one where the controller 100 intermediates between a provider and a social network 200 to distribute information, or, in a particular field, advertisements, to the secondary users. This process can be extended to distribute the information or advertisement to any number of social networks 200. By information or advertisement, it is understood any form of multimedia content that might be used for instance for warning or advertisement purposes. For instance, the information or advertisements may refer to a plain text, an image, a video file, an audio file, and so on.
A third one where the controller 100 records events.

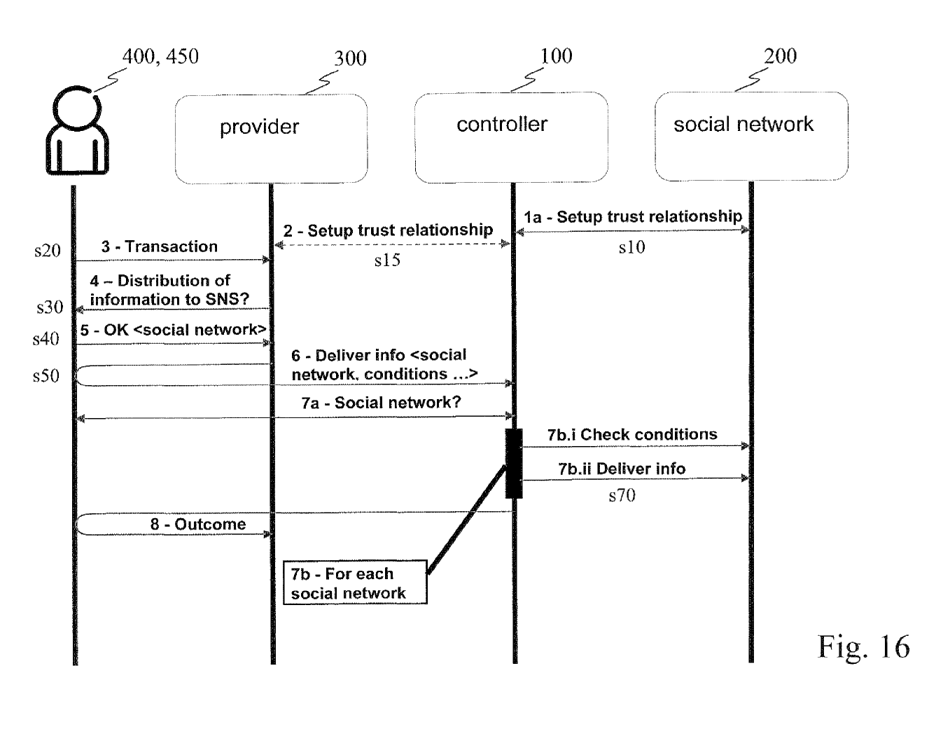

In one embodiment, the following steps are carried out by a provider, the controller 100, one or more social networks, and a user of the one or more social networks. This is illustrated in FIG. 16:

A trust relationship is set up s10 between the controller 100 and a social network 200. Step s10 is labelled “1—Setup trust relationship” in FIG. 16. Step s10 enables the controller 100 to distribute information or advertisements to the social networks 200 and to gain access to the user profile and social graph information at the social networks 200.

Optionally, a trust relationship may be set up s15 between the controller 100 and the provider 300. Step s15 is labelled “2—Setup trust relationship” in FIG. 16. The controller 100 may set up this trust relationship for instance by signing offline contracts and providing the provider 300 with credentials that identify it at the controller 100. Step s15 enables providers 300 to use the capabilities provided by the controller 100, thus preventing unauthorized use of the controller services by non-trusted providers 300. In addition, this step enables providers 300 to set at the controller 100 the conditions to be fulfilled for the distribution of information or advertisements, instead of specifying them on a per-request basis.

In one embodiment, OpenSocial/OAuth is used for setting up of a trust relationship between a controller 100 and a social network 100. The social network 200, acting as a OpenSocial/OAuth-based container, provides the means to set up the trust relationship with the controller 100, acting as an OpenSocial/OAuth-based consumer, so that the controller 100 can access users' profile and social graph. Once the trust relationship has been set up, the controller 100 can gain access to the users' profile and social graph information in the social network 200. Therefore, the controller 100 exchanges protocol keys and shared secrets with the social network 200 as for OAuth protocol. The controller 100 plays the role of OAuth consumer and is therefore registered with all the involved social networks 200 (which play the role of OAuth containers). This process is usually carried out offline, since OAuth does not specify any procedure to follow.

The user, when browsing through the web, gains access s20 to the provider 300. The user carries out a transaction with, i.e. accesses s20, the provider 300. Step s20 is labelled “3—Transaction” in FIG. 16. The process is triggered by the user, who is interacting with the provider 300 (the one interested in distributing information or advertising its products or services or just creating or maintaining a brand image) in order to carry out some transaction. The means by which the user reaches the provider 300 are not directly relevant for the purpose of explaining the invention.

The provider 300 offers s30 to the user 450 the opportunity to advertise this relationship to members of his/her social network, i.e. to his or her secondary users (possibly, in exchange of some advantage, discount, etc.). Step s30 is labelled “4—Distribution of information to SNS?” in FIG. 16. The provider 300 may in this step offer the user one or more pieces of information, or advertisements, to choose from.

Optionally, the provider 300 may also provide a list of supported social networks 200 for the user to choose from (whereas a discount or advantage may be related to the social network). For example, a Brazilian provider 300 may be more interested in Orkut than in Facebook, while a global provider 300 (let's think of Coca-Cola) may be more interested in Facebook that in a local or niche social network. In addition, the conditions that the primary user 450 or his/her secondary users must fulfil may be also provided. Finally, the provider 300 may offer the primary user 450 one or more forms of information or advertisements to choose from.

The primary user 450 accepts s40 the offer. Step s40 is labelled “5—OK <social network>” in FIG. 16. At this point, the user may or may not indicate to the provider 300 the social network(s) 200 in which his/her associated secondary users are hosted.

The provider 300 sends s50 a message to the controller 100 to deliver the chosen piece of information or advertisement. Step s50 is labelled “6—Deliver information <social network, conditions, . . . >” in FIG. 16. The message includes information regarding the pieces of information or advertisement to be distributed. Although different implementations are possible, the provider 300 may send the message through the user's user-agent (e.g., the browser) by means of a redirection, such as an HTTP redirection.

If step s15 took place (establishing a trust relationship between the provider 300 and the controller 100), the message transmitted in step s50 may include the provider-controller agreed credentials or other proof of the trust relationship between the provider 300 and the controller 100.

The message transmitted in step s50 may also include conditions on the information or advertisement delivery such as target groups, forbidden groups, etc. Alternatively, this information could have been provided in step s15, if this step took place.

The message transmitted in step s50 may further include information about the target social network(s), possibly gathered by the provider 300 as a result of step s30.

In other words, in step s50, the provider 300 sends a message to the controller 100 to trigger the distribution of information on its behalf. The message may include information relevant to the transaction if available such as the target social network(s) 200, conditions that the user must fulfil, conditions that the user's social graph must fulfil, etc. In one embodiment, this relevant information is provided in advance by the provider 300 to the controller 100 (as part of a setup stage, such as step s15). The provider 300 may send this message to the controller 100 by different means. In one embodiment, the provider 300 sends the message to the controller 100 through the user's user agent (e.g., the browser) by means of HTTP Redirections.

The controller 100 triggers 570 the distribution of the information, such as the advertisement information, to the secondary users. Optionally, the controller 100 may modify the information or advertisement to be distributed in order to include relevant information that will help to track the success of the information distribution campaign or advertising campaign. The steps that the controller 100 carries out to distribute the information are as follows:
If no target social network has been set in step 50, the controller 100 asks the user 450 for the target social network(s). The user 450 selects one or more social network(s) and sends the information to the controller 100. In other words, if the target social network(s) 200 for the distribution of information has not been set, the controller 100 contacts the user 450 and requests him/her to define a target social network(s) 200 to which the information is to be distributed. The user 450 selects a social network 200 where his/her social network's secondary users are hosted from a set of available social networks 200 to which the controller 100 is able to distribute information. Once the user has chosen one or more target social networks 200, this information is transmitted to the controller 100.
Iteratively, the controller 100 contacts each selected social network 200 to distribute the information or the advertisement.
   If conditions on the information or advertisement delivery have been set, the controller 100 determines whether the conditions are met.
      The controller 100 requests the information needed to the social network 200. Although different implementations are possible, a preferred implementation uses the OAuth/OpenSocial protocols to retrieve this information. This is possible because step s10 of setting up a trust relationship with the social network 200 has been carried out.
      Using the retrieved information, the controller 100 determines whether the conditions are met.
   If conditions are fulfilled, the controller 100 distributes the information or advertisement to the secondary users. The controller 100 sends s70 a message to the social network 200 to add information to the user's profile. The OAuth/OpenSocial protocols may be used to set this information in the user's profile at the social network 200.
The controller 100 sends a message back to the provider 300 with information regarding the outcome of the distribution.

Optionally, if a trust relationship has been setup s15 between the provider 300 and the controller 100 (in step s15), the controller 100 may provide a functionality that allows providers 300 to define features that the controller 100 uses to carry out the distribution of information or advertisements on behalf of the provider 300. Examples of these features may be the conditions that the target users must fulfil, the target piece of the user's social graph that the information or advertisements should reach, the target piece of the user's social graph that the information or advertisement should not reach, and so on.

Additionally, in one embodiment, the controller 100 may be able to record different events regarding users, providers 300, pieces of information of advertisements, information distribution of advertisement campaigns, users' social graphs, social networks 200, etc. This information can be used by the controller 100 to provide different performance indicators to any of users, providers 300 or social networks 200.

In one embodiment, the OpenSocial (“OpenSocial Specification version 0.9”, OpenSocialand Gadgets Specification Group, Apr. 15, 2009, retrieved on Jun. 29, 2010 from http://www.opensocial.org/Technical-Resources/opensocial-spec-v09/OpenSocial-Specification.html) and OAuth (as referred to above) protocols are used.

OpenSocial is a set of APIs that detail methods for gaining access to users' profiles and social graphs i.e. information about people, their activities, their relations, and their personal information. Third party developers can use these APIs to create OpenSocial-based consumer applications that take advantage of users' profiles and social graphs hosted by OpenSocial-based containers that have implemented the OpenSocial APIs.

OpenSocial relies on OAuth to manage access to users' information. OAuth introduces a third role to the traditional client-server authentication/authorization model: the resource owner. In the OAuth model, the consumer (which is not the resource owner, but is acting on his/her behalf) requests access to resources controlled by the resource owner, but hosted by a container, i.e. the social network 200. OAuth allows the social network 200 to verify the identity of the consumer making the request as well as ensuring that the resource owner has authorized the transaction. In accordance with OAuth procedures, which are based on user-agent redirections, resource owners are able to authorize third-party access to their resources without sharing their credentials.

OAuth uses tokens generated by the container instead of the user's credentials in their requests for protected resources. The process uses two token types: request tokens and access tokens. Request tokens are used by the consumer to ask the user to authorize access to the protected resources. The user-authorized request token is then exchanged for an access token. Access tokens are used by the consumer to access the protected resources on behalf of the user.

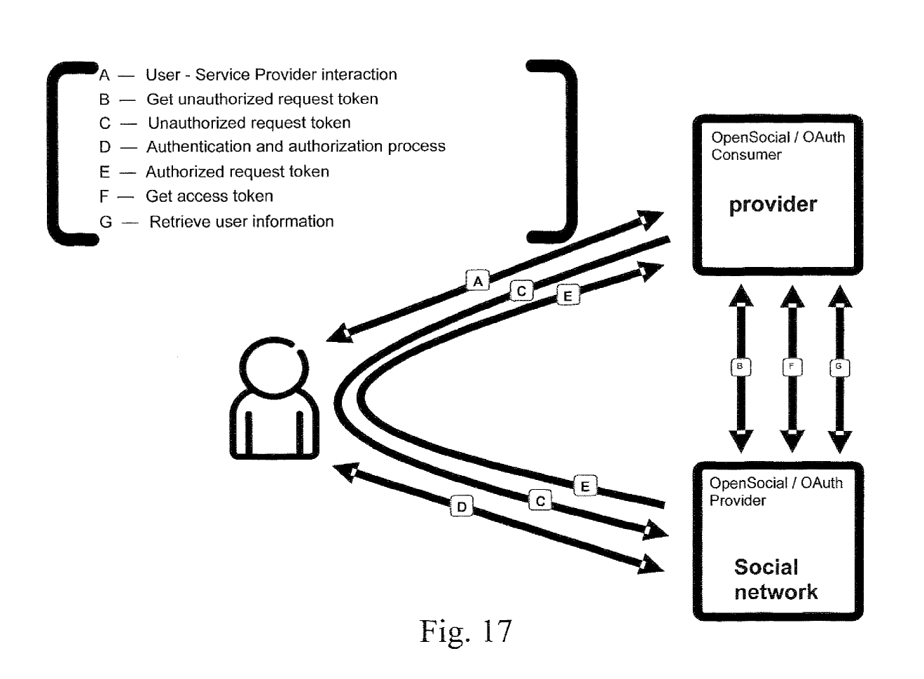

OAuth authentication is the name the OAuth specification gives to the process in which a user grants access to their protected resources at a given container to a consumer without sharing their credentials at said container with the consumer. In one embodiment, the process may comprise three consecutive steps, as illustrated in FIG. 17, which are usually triggered when the user carries out a transaction in the consumer (depicted in FIG. 17, step A).

The consumer obtains an unauthorized request token from the container (FIG. 17, step B).

Through user interaction, she or he authorizes the request token. First, a consumer provides the user with an unauthorized request token that the user agent redirects to the container (FIG. 17, step C). Then, the container begins an authentication dialogue with the user (FIG. 17, step D) which, if successful, implicitly authorizes the request token. Finally, the container provides the user with an authorized request token (FIG. 17, step E), which he or she redirects back to the consumer.

Finally, the consumer exchanges with the container the authorized request token for an access token (FIG. 17, step F). Eventually, an OpenSocial-based consumer application uses the access token to retrieve the desired user profile and social graph information hosted at an OpenSocial-based container (FIG. 17, step G).

Providers 300 on the web requiring profile and social graph information about their users usually play the role of OpenSocial/OAuth-based consumer applications. Accordingly, social networks 200 storing and offering profile and social graph information about their users usually play the role of OpenSocial/OAuth-based containers.

In the OpenSocial/OAuth framework, a given consumer sets up a trust relationship with a given target container by registering as such in the target container. During the registration process, the container provides the consumer with a consumer key and a consumer secret. These elements are used for future dialogues between the consumer and the container, and are generated just once for each container the consumer wants to query (not in a per-user basis).

The physical entities according to the invention, including the controllers, providers, social networks and terminals may comprise or store computer programs including instructions such that, when the computer programs are executed on the physical entities, steps and procedures according to embodiments of the invention are carried out. The invention also relates to such computer programs for carrying out methods according to the invention, and to any computer-readable medium storing the computer programs for carrying out methods according to the invention.

Where the terms “setup unit”, “receiver”, “obtainer”, “triggerer”, “requester”, “determiner”, etc. are used herewith, no restriction is made regarding how distributed these elements may be and regarding how gathered elements may be. That is, the constituent parts of these elements may be distributed in different software or hardware components or devices for bringing about the intended function. A plurality of distinct elements may also be gathered for providing the intended functionalities.

Any one of the above-referred elements of a controller may be implemented in hardware, software, field-programmable gate array (FPGA), application-specific integrated circuit (ASICs), firmware or the like. The same applies to user terminals, consumers and service providers.

In further embodiments of the invention, any one of the above-mentioned setup unit, receiver, obtainer, triggerer, requester, determiner, and the like may be replaced by setter-up, receiving unit, obtaining unit, triggering unit, requesting unit, determining unit and the like, respectively, or by setting-up means, receiving means, obtaining means, triggering means, requesting means, determining means, and the like, respectively, for performing the functions of the setup unit, receiver, obtainer, triggerer, requester, determiner, and the like.

In further embodiments of the invention, any one of the above-described steps may be implemented using computer-readable instructions, for instance in the form of computer-understandable procedures, methods or the like, in any kind of computer languages, and/or in the form of embedded software on firmware, integrated circuits or the like.

Although the present invention has been described on the basis of detailed examples, the detailed examples only serve to provide the skilled person with a better understanding, and are not intended to limit the scope of the invention. The scope of the invention is much rather defined by the appended claims.

1. Method carried out by at least
a controller,
at least one social network,
a provider, and
a terminal of a user, here referred to as primary user,
wherein
each of the at least one social network is at least one of a software application and a web site that is at least configured to maintain profiles of at least the primary user and other users, here referred to as secondary users, who are associated with the primary user in the social network; and
the provider is at least one of a software application and a web site that is at least configured to present and/or offer information, services and/or goods to users;
the method including
setting up a trust relationship between the controller and each of the at least one social network;
accessing, by the terminal of the primary user, the provider;
transmitting, by the provider to the terminal of the primary user, a proposal to provide information relating to the provider at least to some or all secondary users associated with the primary user in the at least one social network;
accepting, by the terminal of the primary user, the proposal;
transmitting, by the provider to the controller, a message including or identifying the information relating to the provider;
obtaining, by the controller, identification of the primary user to whom the message relates; and
triggering, by the controller, the transmission, to some or all secondary users associated with the primary user in the at least one social network, of the information relating to the provider.

2. Method of claim 1, wherein the proposal to provide information relating to the provider at least to some or all secondary users associated with the primary user in the at least one social network is
a proposal to provide information relating to at least one of
the access by the terminal of the primary user to the provider,
the relation between primary user and the provider, and
the interest of the primary user in the information, services and/or goods presented and/or offered by the provider.

3. Method of claim 1, further including a step of setting up a trust relationship between the controller and the provider.

4. Method according to claim 1, wherein transmitting, by the provider to the controller, a message including or identifying the information relating to the provider is carried out by redirection of a browser running on the terminal of the primary user.

5. Method according to claim 1, wherein
transmitting, by the provider to the controller, a message including or identifying the information relating to the provider
further includes
transmitting, by the provider to the controller, at least one of:
information about the at least one social network to which the information relating to the provider is to be transmitted;
information about the secondary users associated with the primary user in the at least one social network to whom the information relating to the provider is to be transmitted; and
at least one condition to be met for the information relating to the provider to be transmitted at least to some or all secondary users associated with the primary user in the at least one social network.

6. Method according to claim 1, further including,
before triggering, by the controller, the transmission, to some or all secondary users associated with the primary user in the at least one social network, of the information relating to the provider,
requesting, by the controller to the terminal of the primary user, and transmitting, by the terminal of the primary user to the controller, at least one of:
information about the at least one social network to which the information relating to the provider is to be transmitted;
information about the secondary users associated with the primary user in the at least one social network to whom the information relating to the provider is to be transmitted; and
at least one condition to be met for the information relating to the provider to be transmitted at least to some or all secondary users associated with the primary user in the at least one social network.

7. Method of claim 5, wherein
the at least one condition includes at least one of:
one or more conditions associated with the primary user,
one or more conditions associated with the secondary users associated with the primary user, and
one or more conditions associated with the at least one social network; and
the method further includes,
before triggering, by the controller, the transmission, to some or all secondary users associated with the primary user in the at least one social network, of the information relating to the provider, determining that the at least one condition is met.

8. Method of claim 7, further including,
before determining that the at least one condition is met,
obtaining, by the controller, information regarding at least one of
the primary user in each of the at least one social network, and
the primary user's social graph in each of the at least one social network, wherein a user's social graph includes the associations between the user and other users in a social network.

9. Method according to claim 1, wherein
triggering, by the controller, the transmission, to some or all secondary users associated with the primary user in the at least one social network, of the information relating to the provider
includes
transmitting, by the controller to the at least one social network, a message causing
the profile of the primary user in each of the at least one social network to be modified, and
the modification to the profile of the primary user to be notified to the some or all secondary users associated with the primary user in the at least one social network.

10. Method according to claim 1, further including:
recording, by the controller, upon receiving a message transmitted from the provider, at least one of:
information regarding the provider from which the message originates;
information regarding the primary user to whom the message relates;
meta-information regarding the information identified or included in the message transmitted by the provider;
information regarding conditions, if any, to be met for the information relating to the provider to be transmitted at least to some or all secondary users associated with the primary user in the at least one social network;
information regarding the at least one social network to which information relating to the provider is transmitted;
information regarding the secondary users to whom information relating to the provider is triggered to be transmitted; and
information regarding the time when information relating to the provider is triggered to be transmitted.

11. Controller including
a setup unit configured for setting up a trust relationship between the controller and at least one social network, wherein
each of the at least one social network is at least one of a software application and a web site that is at least configured to maintain profiles of at least a user, here referred to as primary user, the primary user having a terminal, and other users, here referred to as secondary users, who are associated with the primary user in the at least one social network;
a receiver configured for receiving, from a provider, a message including or identifying information relating to the provider, wherein
the provider is at least one of a software application and a web site that is at least configured to present and/or offer information, services and/or goods to users;
an obtainer configured for obtaining identification of the primary user to whom the message relates; and
a triggerer configured for triggering the transmission, to some or all secondary users associated with the primary user in the at least one social network, of the information relating to the provider.

12. Controller of claim 11, further including
a setup unit configured for setting up a trust relationship between the controller and the provider.

13. Controller of claim 11, wherein
the receiver is further configured for receiving, from the provider, at least one of:
information about the at least one social network to which the information relating to the provider is to be transmitted;
information about the secondary users associated with the primary user in the social network to whom the information relating to the provider is to be transmitted; and
at least one condition to be met for the information relating to the provider (300) to be transmitted at least to some or all secondary users associated with the primary user (450) in the at least one social network (200).

14. Controller of claim 11, further including
a requestor configured for requesting, to the terminal of the primary user, and
a second receiver configured for receiving, from the terminal of the primary user,
at least one of:
information about the at least one social network to which the information relating to the provider is to be transmitted;
information about the secondary users associated with the primary user in the at least one social network to whom the information relating to the provider is to be transmitted; and
at least one condition to be met for the information relating to the provider to be transmitted at least to some or all secondary users associated with the primary user in the at least one social network.

15. Controller of claim 13, wherein
the at least one condition includes at least one of:
one or more conditions associated with the primary user,
one or more conditions associated with the secondary users associated with the primary user, and
one or more conditions associated with the at least one social network; and
the controller further includes
a determiner configured for, before triggering the transmission, to some or all secondary users associated with the primary user in the at least one social network, of the information relating to the provider, determining that the at least one condition is met.

16. Controller of claim 15, further including:
a second obtainer configured for, before determining that the at least one condition is met, obtaining information regarding at least one of
the primary user in each of the at least one social network, and
the primary user's social graph in each of the at least one social network, wherein a user's social graph includes at least the associations between the user and other users in a social network.

17. Controller according to claim 11, wherein
the trigger is configured for triggering, the transmission, to some or all secondary users associated with the primary user in the at least one social network, of the information relating to the provider by transmitting to the at least one social network, a message configured to cause
the profile of the primary user in each of the at least one social network to be modified, and
the modification to the profile of the primary user to be notified to the some or all secondary users associated with the primary user in the at least one social network.

18. Controller according to claim 11, further including:
a recorder configured for recording, upon receiving a message transmitted from the provider, at least one of:
information regarding the provider from which the message originates;
information regarding the primary user to whom the message relates;
information regarding the information identified or included in the message transmitted by the provider;
information regarding conditions, if any, to be met for the information relating to the provider to be transmitted at least to some or all secondary users associated with the primary user in the at least one social network;
information regarding the at least one social network to which information relating to the provider is transmitted;
information regarding the secondary users to whom information relating to the provider is triggered to be transmitted; and
information regarding the time when information relating to the provider is triggered to be transmitted.

19. System including
a controller according to claim 11,
at least one social network,
a provider, and
a terminal of a user, here referred to as primary user,
the at least one social network, the provider, the terminal and the primary user being the same as those first referred to in claim 11,
wherein
each of the at least one social network includes a setup unit configured for setting up a trust relationship with the controller;
the terminal of the primary user includes an access unit configured for accessing the provider;
the provider includes a first sender unit configured for sending, to the terminal of the primary user, a proposal to provide information relating to the provider at least to some or all secondary users associated with the primary user in the at least one social network;
the terminal of the primary user further includes an accepter configured for accepting the proposal;
the provider further includes a second sender unit configured for sending a message including or identifying the information relating to the provider.

20. Computer program comprising instructions configured, when executed on a computer, to cause the computer to act as a controller in accordance to claim 11.
